(19) United States
(12) Patent Application Publication
(10) Pub. No.: US 2025/0365103 A1
(43) Pub. Date: Nov. 27, 2025

(54) SENSING SIGNAL SENDING METHOD AND APPARATUS, SENSING SIGNAL MEASUREMENT METHOD AND APPARATUS, AND DEVICE

(71) Applicant: VIVO MOBILE COMMUNICATION CO., LTD., Dongguan (CN)

(72) Inventors: Jian YAO, Dongguan (CN); Shengli DING, Dongguan (CN)

(21) Appl. No.: 19/293,009

(22) Filed: Aug. 7, 2025

Related U.S. Application Data
(63) Continuation of application No. PCT/CN2024/076506, filed on Feb. 7, 2024.

(30) Foreign Application Priority Data
Feb. 16, 2023 (CN) 202310124194.5

(51) Int. Cl. H04L 5/00; H04J 13/00; H04W 72/044

(52) U.S. Cl. CPC H04L 5/0005; H04J 13/0062; H04W 72/044

(57) ABSTRACT

A sensing signal sending method and apparatus, a sensing signal measurement method and apparatus, and a device are disclosed in the field of communication technologies. The sensing signal sending method in embodiments of this application includes: determining, by a first device, first configuration information, where the first configuration information is used to configure a time-frequency resource pattern of a sensing signal, the time-frequency resource pattern includes at least one resource set used to transmit the sensing signal, and the resource set includes at least two time domain resource elements and at least one frequency domain resource element; and sending, by the first device, the sensing signal based on the time-frequency resource pattern.

### CROSS-REFERENCE TO RELATED APPLICATIONS

This application is a bypass continuation application of International Application No. PCT/CN2024/076506, filed on Feb. 7, 2024, which claims the benefit of and priority to Chinese Patent Application No. 202310124194.5, filed on Feb. 16, 2023, both of which are incorporated herein by reference in its entirety.

### TECHNICAL FIELD

This application relates to the field of communication technologies and, more specifically, relates to a sensing signal sending method and apparatus, a sensing signal measurement method and apparatus, and a device.

### BACKGROUND

Sensing measurements have recently been introduced in some communication systems. These measurements can be used to sense various types of information, such as the orientation, distance, and velocity of a target object. They may also be used to detect, track, identify, or image a target object, event, environment, or the like. In certain related technologies, resource allocation within a communication system is configured to support communication behavior between devices.

### BRIEF SUMMARY

Embodiments of this application provide a sensing signal sending method and apparatus, a sensing signal measurement method and apparatus, and a device.

According to a first aspect, a sensing signal sending method is provided, including:
determining, by a first device, first configuration information, where the first configuration information is used to configure a time-frequency resource pattern of a sensing signal, the time-frequency resource pattern includes at least one resource set used to transmit the sensing signal, and the resource set includes at least two time domain resource elements and at least one frequency domain resource element; and
sending, by the first device, the sensing signal based on the time-frequency resource pattern.

According to a second aspect, a sensing signal measurement method is provided, including:
determining, by a second device, first configuration information, where the first configuration information is used to configure a time-frequency resource pattern of a sensing signal, the time-frequency resource pattern includes at least one resource set used to transmit the sensing signal, and the resource set includes at least two time domain resource elements and at least one frequency domain resource element; and
measuring, by the second device, the sensing signal based on the first configuration information.

According to a third aspect, a sensing signal sending apparatus is provided, including:
a determining module, configured to determine first configuration information, where the first configuration information is used to configure a time-frequency resource pattern of a sensing signal, the time-frequency resource pattern includes at least one resource set used to transmit the sensing signal, and the resource set includes at least two time domain resource elements and at least one frequency domain resource element; and
a first sending module, configured to send the sensing signal based on the time-frequency resource pattern.

According to a fourth aspect, a sensing signal measurement apparatus is provided, including:
a determining module, configured to determine first configuration information, where the first configuration information is used to configure a time-frequency resource pattern of a sensing signal, the time-frequency resource pattern includes at least one resource set used to transmit the sensing signal, and the resource set includes at least two time domain resource elements and at least one frequency domain resource element; and
a measurement module, configured to measure the sensing signal based on the first configuration information.

According to a fifth aspect, a communication device is provided. The communication device includes a processor and a memory. The memory stores a program or instructions capable of running on the processor, and the program or the instructions are executed by the processor to implement the steps of the sensing signal sending method provided in the embodiments of this application.

According to a sixth aspect, a communication device is provided, including a processor and a communication interface. The processor or the communication interface is configured to determine first configuration information, where the first configuration information is used to configure a time-frequency resource pattern of a sensing signal, the time-frequency resource pattern includes at least one resource set used to transmit the sensing signal, and the resource set includes at least two time domain resource elements and at least one frequency domain resource element. The communication interface is configured to send the sensing signal based on the time-frequency resource pattern.

According to a seventh aspect, a communication device is provided. The communication device includes a processor and a memory. The memory stores a program or instructions capable of running on the processor, and the program or the instructions are executed by the processor to implement the steps of the sensing signal measurement method provided in the embodiments of this application.

According to an eighth aspect, a communication device is provided, including a processor and a communication interface. The processor or the communication interface is configured to determine first configuration information, where the first configuration information is used to configure a time-frequency resource pattern of a sensing signal, the time-frequency resource pattern includes at least one resource set used to transmit the sensing signal, and the resource set includes at least two time domain resource elements and at least one frequency domain resource element. The communication interface is configured to measure the sensing signal based on the first configuration information.

According to a ninth aspect, a sensing measurement system is provided, including a first device and a second device. The first device may be configured to perform the steps of the sensing signal sending method provided in the embodiments of this application, and the second device may be configured to perform the steps of the sensing signal measurement method provided in the embodiments of this application.

According to a tenth aspect, a readable storage medium is provided. The readable storage medium stores a program or instructions, and the program or the instructions are executed by a processor to implement the steps of the sensing signal sending method provided in the embodiments of this application, or implement the steps of the sensing signal measurement method provided in the embodiments of this application.

According to an eleventh aspect, a chip is provided. The chip includes a processor and a communication interface. The communication interface is coupled to the processor. The processor is configured to run a program or instructions to implement the sensing signal sending method provided in the embodiments of this application, or implement the sensing signal measurement method provided in the embodiments of this application.

According to a twelfth aspect, a computer program/program product is provided. The computer program/program product is stored in a storage medium. The computer program/program product is executed by at least one processor to implement the steps of the sensing signal sending method provided in the embodiments of this application, or the computer program/program product is executed by at least one processor to implement the steps of the sensing signal measurement method provided in the embodiments of this application.

### BRIEF DESCRIPTION OF DRAWINGS

FIG. 1 is a block diagram of a wireless communication system applicable to an embodiment of this application;

FIG. 2 is a schematic diagram of a scenario of sensing measurement according to an embodiment of this application;

FIG. 3 is a flowchart of a sensing signal sending method according to an embodiment of this application;

FIG. 4 is a schematic diagram of a time-frequency resource pattern according to an embodiment of this application;

FIG. 5 is a schematic diagram of a resource set according to an embodiment of this application;

FIG. 6 is a schematic diagram of another resource set according to an embodiment of this application;

FIG. 7 is a schematic diagram of another resource set according to an embodiment of this application;

FIG. 8 is a schematic diagram of another resource set according to an embodiment of this application;

FIG. 9 is a schematic diagram of SNR calculation according to an embodiment of this application;

FIG. 10 is a flowchart of a sensing signal measurement method according to an embodiment of this application;

FIG. 11 is a schematic diagram of another resource set according to an embodiment of this application;

FIG. 12 is a schematic diagram of a measurement result according to an embodiment of this application;

FIG. 13 is a schematic diagram of another measurement result according to an embodiment of this application;

FIG. 14 is a structural diagram of a sensing signal sending apparatus according to an embodiment of this application;

FIG. 15 is a structural diagram of a sensing signal measurement apparatus according to an embodiment of this application;

FIG. 16 is a structural diagram of a communication device according to an embodiment of this application;

FIG. 17 is a structural diagram of another communication device according to an embodiment of this application; and

FIG. 18 is a structural diagram of another communication device according to an embodiment of this application.

### DETAILED DESCRIPTION

The following describes technical solutions in embodiments of this application with reference to accompanying drawings in the embodiments of this application. Understandably, the described embodiments are merely some rather than all of the embodiments of this application. All other embodiments obtained by a person of ordinary skill in the art based on the embodiments of this application shall fall within the protection scope of this application.

The terms “first”, “second”, and the like in this application are used to distinguish between similar objects instead of describing a specified order or sequence. It should be understood that terms used in this way may be interchangeable under appropriate circumstances, so that the embodiments of this application can be implemented in an order other than that illustrated or described herein. Moreover, the terms “first” and “second” typically distinguish between objects of one category rather than limiting a quantity of objects. For example, there may be one or more first objects. In addition, “or” in this application represents at least one of connected objects. For example, “A or B” covers three solutions: Solution 1: A is included and B is not included; Solution 2: B is included and A is not included; and Solution 3: Both A and B are included. The character “/” generally represents an “or” relationship between associated objects.

The term “indication” in this application may be either a direct indication (or an explicit indication) or an indirect indication (or an implicit indication). The direct indication may be understood as: A sender explicitly notifies, in a sent indication, a receiver of specific information, an operation that needs to be performed, a requested result, or other content. The indirect indication may be understood as: The receiver determines corresponding information based on the indication sent by the sender, or performs determining based on the indication sent by the sender, and determines, based on a determining result, the operation that needs to be performed or the requested result.

It should be noted that, a technology described in embodiments of this application is not limited to a long term evolution (LTE)/LTE-advanced (LTE-A) system, and may be further applied to other wireless communication systems, such as a code division multiple access (CDMA) system, a time division multiple access (TDMA) system, a frequency division multiple access (FDMA) system, an orthogonal frequency division multiple access (OFDMA) system, a single-carrier frequency-division multiple access (SC-FDMA) system, or another system. The terms “system” and “network” are often used interchangeably in the embodiments of this application. The technology described may be used for the systems and radio technologies described above, as well as other systems and radio technologies. The following describes a new radio (NR) system for illustrative purposes, and NR terms are used in most of the following descriptions. However, these technologies are also applicable to systems such as a 6th generation (6G) communication system other than the NR system.

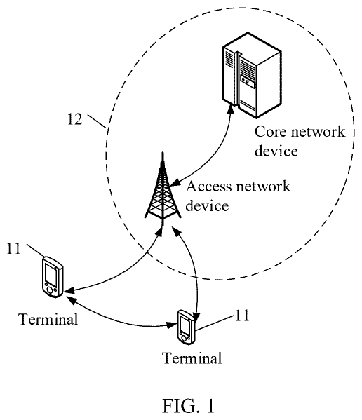

FIG. 1 is a block diagram of a wireless communication system applicable to an embodiment of this application. The wireless communication system includes a terminal 11 and a network side device 12. The terminal 11 may be a mobile phone, a tablet personal computer, a laptop computer, a notebook computer, a personal digital assistant (PDA), a palmtop computer, a netbook, an ultra-mobile personal computer (UMPC), a mobile internet device (MID), an augmented reality (AR)/virtual reality (VR) device, a robot, a wearable device, a flight vehicle, vehicle user equipment (VUE), ship-mounted equipment, pedestrian user equipment (PUE), a smart home (a home device with a wireless communication function, for example, a refrigerator, a television, a laundry machine, or a furniture), a gaming console, a personal computer (PC), a teller machine, a self-service machine, or another terminal side device. The wearable device includes: a smart watch, a smart band, a smart headset, smart glasses, smart jewelry (a smart bracelet, a smart wristlet, a smart ring, a smart necklace, a smart anklet, a smart leglet, and the like), a smart wristband, smart clothing, and the like. The vehicle user equipment may also be referred to as a vehicle-mounted terminal, a vehicle-mounted controller, a vehicle-mounted module, a vehicle-mounted component, a vehicle-mounted chip, a vehicle-mounted unit, or the like. It should be noted that a specific type of the terminal 11 is not limited in the embodiments of this application. The network side device 12 may include an access network device or a core network device. The access network device may also be referred to as a radio access network (RAN) device, a radio access network function, or a radio access network unit. The access network device may include a base station, a wireless local area network (WLAN) access point (AP), a Wireless Fidelity (Wi-Fi) node, and the like. The base station may be referred to as a NodeB (NodeB, NB), an evolved NodeB (eNB), the next generation NodeB (gNB), a new radio NodeB (NR NodeB), an access point, a relay base station (RBS), a serving base station (SBS), a base transceiver station (BTS), a radio base station, a radio transceiver, a basic service set (BSS), an extended service set (ESS), a home NodeB (HNB), a home evolved NodeB (NodeB), a transmission reception point (TRP), or another proper term in the field. The base station is not limited to a specific technical term, provided that the same technical effect is achieved. It should be noted that in the embodiments of this application, only a base station in an NR system is used as an example for description, and a specific type of the base station is not limited.

The core network device may include but is not limited to at least one of the following: a core network node, a core network function, a mobility management entity (MME), an access and mobility management function (AMF), a session management function (SMF), a user plane function (UPF), a policy control function (PCF), a policy and charging rules function (PCRF) unit, an edge application server discovery function (EASDF), unified data management (UDM), a unified data repository (UDR), a home subscriber server (HSS), a centralized network configuration (CNC), a network repository function (NRF), a network exposure function (NEF), a local NEF (L-NEF), a binding support function (BSF), an application function (AF), and the like. It should be noted that in the embodiments of this application, only a core network device in the NR system is used as an example for description, and a specific type of the core network device is not limited. The core network device may include but is not limited to at least one of the following: a core network node, a core network function, a mobility management entity (MME), an access and mobility management function (AMF), a session management function (SMF), a user plane function (UPF), a policy control function (PCF), a policy and charging rules function (PCRF) unit, an edge application server discovery function (EASDF), unified data management (UDM), a unified data repository (UDR), a home subscriber server (HSS), a centralized network configuration (CNC), a network repository function (NRF), a network exposure function (NEF), a local NEF (L-NEF), a binding support function (BSF), an application function (AF), and the like. It should be noted that in the embodiments of this application, only a core network device in the NR system is used as an example for description, and a specific type of the core network device is not limited.

In this embodiment of this application, the network side device and the terminal may have a sensing capability, and can sense information such as an orientation, a distance, and a velocity of a target object by sending and receiving a wireless signal, or detect, track, identify, and image a target object, an event, an environment, or the like.

For example, a system such as a beyond 5th generation (B5G) system or a 6G system has a sensing capability in addition to a communication capability. The sensing capability means that one or more devices that have the sensing capability can sense information such as an orientation, a distance, and a velocity of a target object by sending and receiving a wireless signal, or detect, track, identify, and image a target object, an event, an environment, or the like. In the future, with the deployment of a small base station with a capability of a high frequency band and large bandwidth such as a millimeter wave and terahertz in a 6G network, resolution of sensing is significantly improved when compared with that of a centimeter wave, so that the 6G network can provide a more refined sensing service. Typical sensing functions and application scenarios are shown in Table 1.

Some sensing functions and application scenarios are shown in Table 1.

TABLE 1

| Sensing type | Sensing function | Application scenario |
|---|---|---|
| Macro | Weather, air quality, and the like | Meteorology, agriculture, and life |
| sensing | | services |
| type | Traffic flow (intersections) and | Smart city, smart transportation, |
| | crowd flow (subway entrances) | and commercial services |
| | Target tracking, distance | Many application scenarios of a |
| | measurement, velocity | conventional radar |
| | measurement, outlining, and the | |
| | like | |
| | Environment reconstruction | Intelligent driving and navigation |
| | | (automobiles/unmanned aerial |
| | | vehicles), smart city (3D maps), |
| | | and network planning and |
| | | network optimization |
| Granular | Action, posture, and expression | Smart interaction of smartphones, |
| sensing | recognition | games, and smart home |
| type | Heartbeat, breathing, and the like | Health and medical care |
| | Imaging, material detection, | Security inspection, industry, |
| | component analysis, and the like | biological medicine, and the like |

It should be noted that the sensing category shown in the foregoing Table 1 is merely an example for description, and a sensing measurement category is not limited in this embodiment of this application.

In addition, this embodiment of this application may be applied to an integrated communication and sensing scenario. Integrated communication and sensing means that in a same system, a design of integrated communication and sensing functions is implemented through spectrum sharing and hardware sharing. When transferring information, the system can sense information such as an orientation, a distance, and a velocity, and detect, track, and identify a target device or an event. A communication system and a sensing system cooperate with each other, to improve overall performance and bring better service experience.

For example, integration of communication and radar is a typical integrated communication and sensing (fusion of communication and sensing) application, and fusion of a communication system and a radar system can bring many advantages, for example, cost saving, size reduction, power consumption reduction, spectrum efficiency improvement, and mutual interference reduction, thereby improving overall system performance.

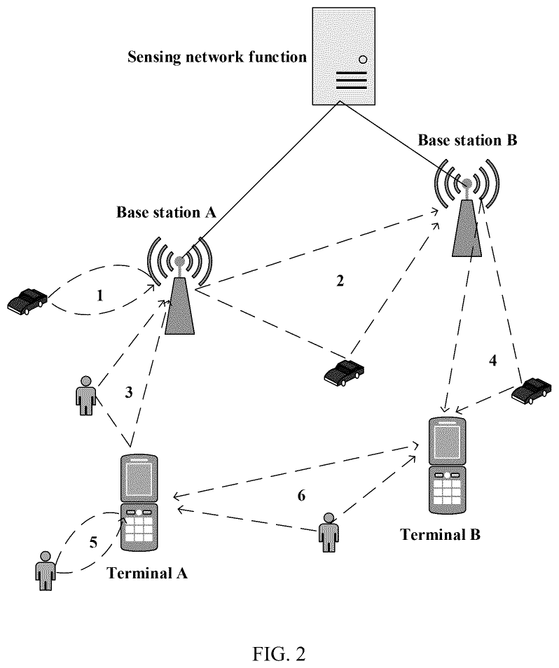

In this embodiment of this application, based on different sensing signal sending nodes and receiving nodes, six types of sensing links shown in FIG. 2 are included, which constitute no limitations. It should be noted that each type of sensing link in FIG. 2 is described by using one sending node and one receiving node as an example. In an actual system, different sensing links may be selected based on different sensing requirements. There may be one or more sending nodes and one or more receiving nodes for each type of sensing link, and an actual sensing system may include a plurality of different sensing links. In addition, in FIG. 2, a human and a vehicle are used as an example of a sensing target, and there are richer sensing targets in an actual scenario.

Sensing link 1: Self-sending and self-receiving sensing of a base station: In this manner, the base station sends a sensing signal, and obtains a sensing result by receiving an echo of the sensing signal.

Sensing link 2: Air-interface sensing between base stations: In this manner, a base station 2 receives a sensing signal sent by a base station 1, and obtains a sensing result.

Sensing link 3: Uplink air-interface sensing: In this manner, a base station receives a sensing signal sent by a terminal, and obtains a sensing result.

Sensing link 4: Downlink air-interface sensing: In this manner, a terminal receives a sensing signal sent by a base station, and obtains a sensing result.

Sensing link 5: Self-sending and self-receiving sensing of a terminal: In this manner, the terminal sends a sensing signal, and obtains a sensing result by receiving an echo of the sensing signal.

Sensing link 6: Sidelink sensing between terminals: For example, a terminal 2 receives a sensing signal sent by a terminal 1, and obtains a sensing result, or a terminal 1 receives a sensing signal sent by a terminal 2, and obtains a sensing result.

With reference to the accompanying drawings, the following describes in detail, by using some embodiments and application scenarios thereof, the sensing signal sending method and apparatus, the sensing signal measurement method and apparatus, and the device that are provided in the embodiments of this application.

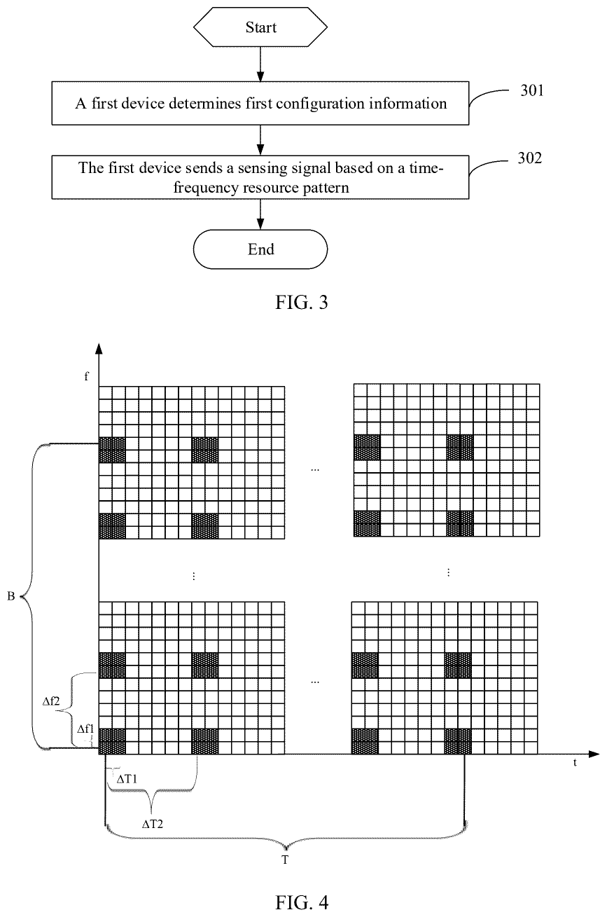

Referring to FIG. 3, FIG. 3 is a flowchart of a sensing signal sending method according to an embodiment of this application. As shown in FIG. 3, the method includes the following steps.

Step 301: A first device determines first configuration information, where the first configuration information is used to configure a time-frequency resource pattern of a sensing signal, the time-frequency resource pattern includes at least one resource set used to transmit the sensing signal, and the resource set includes at least two time domain resource elements and at least one frequency domain resource element.

The first device may be a terminal or a network side device.

The first configuration information may be determined by the first device based on a sensing requirement, or may be received by the first device and sent by another device.

The first configuration information may be used to explicitly or implicitly configure the time-frequency resource pattern.

The time-frequency resource pattern may include one or more resource sets. These resource sets are resources used to transmit the sensing signal. Each resource set includes at least two time domain resource elements and includes at least one frequency domain resource element.

The time domain resource element may be a symbol, a slot, a sub-slot, a subframe, a half-frame, a frame, or another time domain resource element, and the frequency domain resource element may be a resource element (RE), a quantity of resource blocks (RB), a quantity of resource block groups (RBG), or another frequency domain resource element.

After determining the time-frequency resource pattern, the first device may determine the at least one resource set used to transmit the sensing signal.

In some implementations, the time-frequency resource pattern may be a time-frequency resource pattern shown in FIG. 4. Each resource set in the time-frequency resource pattern shown in FIG. 4 includes two time domain resource elements and two frequency-domain resource elements, that is, four time-frequency domain resource elements form a resource set.

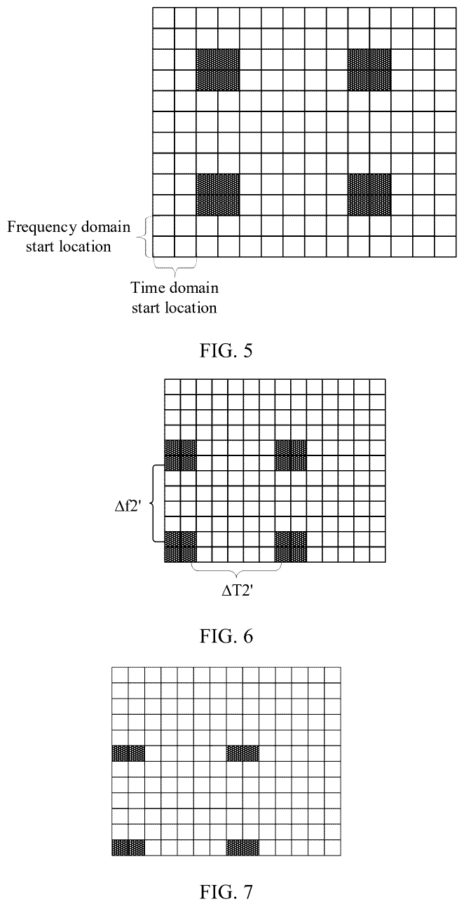

In some implementations, the time-frequency resource pattern may alternatively be a time-frequency resource pattern shown in FIG. 5. Each resource set in the time-frequency resource pattern shown in FIG. 5 includes two time domain resource elements and one frequency domain resource element, that is, two time-frequency domain resource elements form a resource set.

In some implementations, the time-frequency resource pattern may be a time-frequency domain resource pattern formed by using a resource set as a basic unit.

It should be noted that, in this embodiment of this application, a resource set is a resource used to transmit the sensing signal, and the resource set may also be referred to as another name, for example, a sensing signal transmission resource, a target resource, an available resource, or a resource bundle.

Step 302: The first device sends the sensing signal based on the time-frequency resource pattern.

The sending, by the first device, the sensing signal based on the time-frequency resource pattern may be sending the sensing signal on all or a part of resource sets included in the time-frequency resource pattern.

In this embodiment of this application, through the foregoing steps, the sensing signal may be sent based on the time-frequency resource pattern configured for the sensing signal, so that transmission reliability of the sensing signal can be improved, and sensing measurement performance can be further improved.

In an optional implementation, the sensing signal is used for at least one of the following:
velocity estimation, Doppler estimation, distance estimation, delay estimation, and angle estimation.

In this implementation, at least one of velocity estimation, Doppler estimation, distance estimation, delay estimation, and angle estimation may be performed through measurement of the sensing signal. Measurement of the sensing signal may be as follows: The first device sends the sensing signal, and another device measures the sensing signal; or the first device sends the sensing signal, and the first device measures the sensing signal based on an echo signal of the sensing signal.

In this implementation, because the sensing signal may be used for at least one of velocity estimation, Doppler estimation, distance estimation, delay estimation, and angle estimation, sensing performance can be improved.

In an optional implementation, the sensing signal includes:
a signal generated based on at least one of an M sequence, a Gold sequence, a Kasami sequence, a Golay sequence, and a Zadoff-Chu sequence;
communication data;
a radar signal; or
an integrated communication and sensing signal.

The M sequence, the Gold sequence, the Kasami sequence, the Golay sequence, and the Zadoff-Chu sequence are sequences defined in a protocol. In this implementation, a sensing signal designed based on these sequences may be implemented. In this way, a sensing signal can be independently designed, and transmission reliability of the sensing signal can be improved.

The communication data may be communication data that needs to be sent by the first device. In this way, sensing measurement may be performed based on a communication signal, thereby saving signal overheads.

The radar signal may be a linear frequency modulation signal or a common radar signal. In this way, because the radar signal is used for sensing measurement, no additional signal needs to be introduced, thereby reducing complexity of sensing measurement.

The integrated communication and sensing signal may be a newly designed integrated communication and sensing signal. In this way, a sense signal can be independently designed, and transmission reliability of the sense signal can be improved.

In an optional implementation, the resource set meets an unambiguous measurement requirement.

The unambiguous measurement requirement may include at least one of an unambiguous Doppler measurement requirement, an unambiguous velocity measurement requirement, an unambiguous delay measurement requirement, and an unambiguous distance measurement requirement.

That the resource set meets the unambiguous measurement requirement may be that the sensing signal is sent on the resource set, and measurement of the sensing signal can meet the unambiguous measurement requirement.

In some implementations, each resource set in the time-frequency resource pattern may meet the unambiguous measurement requirement.

The unambiguous measurement requirement may be an unambiguous measurement requirement defined in the protocol.

In addition, the unambiguous measurement requirement may be a maximum unambiguous measurement range requirement.

In this implementation, the resource set meets the unambiguous measurement requirement. In this way, when the sensing signal is sent on the resource set, measurement of the sensing signal can meet the unambiguous measurement requirement, thereby improving measurement performance of sensing measurement.

Optionally, a time domain difference between neighboring time domain resource elements in the resource set meets at least one of the following: an unambiguous Doppler measurement requirement and an unambiguous velocity measurement requirement; or
a time domain density in the resource set meets at least one of the following: an unambiguous Doppler measurement requirement and an unambiguous velocity measurement requirement.

The time domain difference between the neighboring time domain resource elements in the resource set may be a time domain difference between two neighboring time domain resource elements. For example, as shown in FIG. 4, the time domain difference between the neighboring time domain resource elements in the resource set is ΔT1.

Using monostatic radar sensing an example, that the time domain difference between the neighboring time domain resource elements in the resource set meets the unambiguous Doppler measurement requirement or the unambiguous velocity measurement requirement may include at least one of the following:
if a velocity direction is considered, ΔT1≤1/(2|f_{dmax}|) or ΔT1≤c/(4f_{c}|vₘₐₓ|); or
if the velocity direction is not considered, ΔT1≤1/f_{dmax} or ΔT1≤c/(2f_{c}vₘₐₓ).

ΔT1 represents the time domain difference between the neighboring time domain resource elements in the resource set, f_{dmax} is a maximum unambiguous Doppler, vₘₐₓ is a maximum unambiguous velocity, f_{c} is a carrier frequency, and c is velocity of light.

In some implementations, Doppler ambiguity and velocity ambiguity may be as follows:

Doppler calculation at a receive end needs to be based on a time domain phase change of the sensing signal, that is, 2πf_{d}ΔT=θ, where Θ is the time domain phase change of the sensing signal in time ΔT, ΔT is a time domain difference (also referred to as a time domain interval) between time domain resource elements, and f_{d} is Doppler ambiguity. When a velocity direction is not considered, to ensure that no Doppler ambiguity occurs, θ=2πf_{d}ΔT≤2π needs to be met, that is, a relationship between a maximum unambiguous Doppler and a time domain interval of the sensing signal is ΔT≤1/(f_{d max}). Using monostatic radar as an example, a relationship between a maximum unambiguous velocity (for example, a radial velocity) and the maximum unambiguous Doppler is vₘₐₓ=f_{d max}c/2f_{c}. Therefore, a relationship between the maximum unambiguous velocity and the time domain interval of the sensing signal is ΔT≤c/(2f_{c}vₘₐₓ). When the velocity direction is considered, to ensure that no Doppler ambiguity occurs, θ=|2πf_{d}ΔT|≤π needs to be met, that is, the relationship between the maximum unambiguous Doppler and the time domain interval of the sensing signal is ΔT₁≤1/(2|f_{d max}|), and the relationship between the maximum unambiguous velocity and the time domain interval of the sensing signal is ΔT₁≤c/(4f_{c}|vₘₐₓ|), where ΔT₁ represents the time domain difference between the neighboring time domain resource elements in the resource set.

That the time domain density in the resource set meets at least one of the unambiguous Doppler measurement requirement and the unambiguous velocity measurement requirement may be as follows: The time domain difference that is between the neighboring time domain resource elements in the resource set and that corresponds to the time domain density in the resource set meets at least one of the unambiguous Doppler measurement requirement and the unambiguous velocity measurement requirement.

In the foregoing implementation, the time domain difference between the neighboring time domain resource elements in the resource set or the time domain density in the resource set meets at least one of the unambiguous Doppler measurement requirement and the unambiguous velocity measurement requirement. In this way, when the sensing signal is sent on the resource set, measurement of the sensing signal meets at least one of the unambiguous Doppler measurement requirement and the unambiguous velocity measurement requirement, thereby improving measurement performance of sensing measurement.

Optionally, a frequency domain difference between neighboring frequency domain resource elements in the resource set meets at least one of the following: an unambiguous delay measurement requirement and an unambiguous distance measurement requirement; or
a frequency domain density in the resource set meets at least one of the following: an unambiguous delay measurement requirement and an unambiguous distance measurement requirement.

The frequency domain difference between the neighboring frequency domain resources in the resource set may be a frequency domain difference between two neighboring frequency resource elements. For example, as shown in FIG. 4, the frequency domain difference between the neighboring frequency domain resources in the resource set is Δf1.

Using monostatic radar sensing an example, that the frequency domain difference between the neighboring frequency domain resources in the resource set meets the unambiguous delay measurement requirement and the unambiguous distance measurement requirement may include at least one of the following:

$$Δ f 1 \leq 1 / {τ}_{max} , or$$

$$Δ f 1 \leq c / ( 2 {R}_{max} ) ,$$

where
Δf1 represents the frequency domain difference between the neighboring frequency domain resources in the resource set, τₘₐₓ is a maximum unambiguous delay, and Rₘₐₓ is a maximum unambiguous distance.

In some implementations, distance ambiguity and delay ambiguity may be as follows:

Delay calculation at a receive end needs to be based on a frequency domain phase difference of the sensing signal, that is 2πΔf1τ=θ, where Θ is a sensing signal phase difference in a frequency domain interval Δf1. To ensure that no time delay ambiguity occurs, θ=2πΔf1τₘₐₓ≤2π needs to be met, that is, a relationship between a maximum unambiguous delay and the frequency domain interval of the sensing signal is Δf1≤1/τₘₐₓ. Using a monostatic radar as an example, a relationship between a maximum unambiguous distance and the maximum unambiguous delay is Rₘₐₓ=cτₘₐₓ/2, and a relationship between the maximum unambiguous distance and the frequency domain interval of the sensing signal is Δf1≤c/(2Rₘₐₓ).

That the frequency domain density in the resource set meets at least one of the unambiguous delay measurement requirement and the unambiguous distance measurement requirement may be as follows: The frequency domain difference that is between the neighboring frequency domain resource elements in the resource set and that corresponds to the frequency domain density in the resource set meets at least one of the unambiguous delay measurement requirement and the unambiguous distance measurement requirement.

In the foregoing implementation, the frequency domain difference between the neighboring frequency domain resource elements in the resource set or the frequency domain density in the resource set meets at least one of the unambiguous delay measurement requirement and the unambiguous distance measurement requirement. In this way, when the sensing signal is sent on the resource set, measurement of the sensing signal meets at least one of the unambiguous delay measurement requirement and the unambiguous distance measurement requirement, thereby improving measurement performance of sensing measurement.

In an optional implementation, the first configuration information includes at least one of the following:
index information of the resource set; and
parameter information of the resource set.

The index information of the resource set may include index information of the resource set in the time-frequency resource pattern, for example, indicates the resource set that is in the time-frequency resource pattern and that is used to transmit the sensing signal.

In some implementations, the index information of the resource set may also indicate the time-frequency resource pattern. For example, indexes of resource sets in different time-frequency resource patterns are different. In this way, the index information of the resource set may implicitly indicate the time-frequency resource pattern of the sensing signal.

The parameter information of the resource set may include at least one of the following:
a quantity of resource elements in the resource set, the time domain difference between the neighboring time domain resource elements in the resource set, the time domain density in the resource set, the frequency domain difference between the neighboring frequency domain resource elements in the resource set, and the frequency domain density in the resource set.

The quantity of resource elements in the resource set may be a resource set size, for example, indicates how many time-frequency domain resource elements form a resource set.

In some implementations, the quantity of resource elements in the resource set may include at least one of the following:
a total quantity of resource elements in the resource set;
a quantity of frequency domain resource elements (or a frequency domain resource length) in the resource set; and
a quantity of time domain resource elements (or a time domain resource length) in the resource set.

In addition, in some implementations, it may be considered by default that in the resource set, the quantity of frequency domain resource elements is the same as the quantity of time domain resource elements.

In some implementations, it may be considered by default that the time domain difference between the neighboring time domain resource elements in the resource set is the same as the frequency domain difference between the neighboring frequency domain resource elements in the resource set, or it may be considered by default that the time domain density in the resource set is the same as the frequency domain density in the resource set, or it may be considered by default that the time domain difference between the neighboring time domain resource elements in the resource set and the frequency domain difference between the neighboring frequency domain resource elements in the resource set include only a common resource interval parameter.

In the foregoing implementation, the index information of the resource set and the parameter information of the resource set maybe used to more accurately indicate a resource used to transmit the sensing signal, to improve accuracy of resource allocation.

In addition, the time-frequency resource pattern may also be configured by using the parameter information of the resource set, for example, parameter information of resource sets in different time-frequency resource patterns is different. In this way, the time-frequency resource pattern of the sensing signal may be configured by using the parameter information of the resource set.

In an optional implementation, the time-frequency resource pattern meets a resolution requirement.

The resolution requirement may include at least one of a Doppler resolution requirement, a velocity resolution requirement, a delay resolution requirement, and a distance resolution requirement.

That the time-frequency resource pattern meets the resolution requirement may be that the sensing signal is sent on the time-frequency resource pattern, and measurement of the sensing signal can meet the resolution requirement.

The resolution requirement may be a resolution requirement defined in the protocol.

In this implementation, the time-frequency resource pattern meets the resolution requirement. In this way, when the sensing signal is sent on the time-frequency resource pattern, measurement of the sensing signal can meet the resolution requirement, thereby improving measurement performance of sensing measurement.

Optionally, a time domain resource length of the time-frequency resource pattern meets at least one of the following: a Doppler resolution requirement and a velocity resolution requirement.

The time domain resource length of the time-frequency resource pattern may be coherent processing time of the time-frequency resource pattern. For example, as shown in FIG. 4, the time domain resource length of the time-frequency resource pattern is T.

Using monostatic radar sensing as an example, that the time domain resource length of the time-frequency resource pattern meets the Doppler resolution requirement or the velocity resolution requirement may include at least one of the following:

$$T \geq 1 / Δ {f}_{d} , or$$

$$T \geq c / ( 2 {f}_{c} Δ v ) ,$$

where
T represents the time domain resource length of the time-frequency resource pattern, Δf_{d} is Doppler resolution, and Δv is velocity resolution.

In this implementation, the time domain resource length of the time-frequency resource pattern meets at least one of the Doppler resolution requirement and the velocity resolution requirement. In this way, when the sensing signal is sent on the time-frequency resource pattern, measurement of the sensing signal can meet at least one of the Doppler resolution requirement and the velocity resolution requirement, thereby improving measurement performance of sensing measurement.

Optionally, a frequency domain resource length of the time-frequency resource pattern meets at least one of the following: a delay resolution requirement and a distance resolution requirement.

The frequency domain resource length of the time-frequency resource pattern may be a bandwidth of the time-frequency resource pattern. For example, as shown in FIG. 4, the frequency domain resource length of the time-frequency resource pattern is B.

Using monostatic radar sensing as an example, that the frequency domain resource length of the time-frequency resource pattern meets the delay resolution requirement or the distance resolution requirement may include at least one of the following:

$$B \geq 1 / Δτ , or$$

$$B \geq c / ( 2 Δ R ) ,$$

where
B represents the frequency domain resource length of the time-frequency resource pattern, Δτ is delay resolution, and ΔR is distance resolution.

In this implementation, the frequency domain resource length of the time-frequency resource pattern meets at least one of the delay resolution requirement or the distance resolution requirement. In this way, when the sensing signal is sent on the time-frequency resource pattern, measurement of the sensing signal can meet at least one of the delay resolution requirement or the distance resolution requirement, thereby improving measurement performance of sensing measurement.

In an optional implementation, the first configuration information includes at least one of the following:
index information of the time-frequency resource pattern; and
parameter information of the time-frequency resource pattern.

In this implementation, the time-frequency resource pattern may be directly and simply configured by using the index information of the time-frequency resource pattern.

The parameter information of the time-frequency resource pattern may include at least one of the following:
time domain resource length information, frequency domain resource length information, a start location of the resource set, and a resource difference between neighboring resource sets.

The time domain resource length information may be a total time domain resource length of the time-frequency resource pattern, and the frequency domain resource length information may be a total frequency resource length of the time-frequency resource pattern.

The time domain resource length information may be a time domain length of the time-frequency resource pattern, for example, T in the foregoing implementation, and the frequency domain resource length information may be a frequency domain length of the time-frequency resource pattern, for example, B in the foregoing implementation.

In some implementations, the time domain resource length information indicates at least one of the following:
a quantity of time domain resource sets;
a quantity of scheduled resource elements, where for example, a time domain resource length includes a quantity of symbols, a quantity of slots, a quantity of subframes, a quantity of half-frames, and a quantity of frames; and
actual duration.

In some implementations, the frequency domain resource length information indicates at least one of the following:
a quantity of frequency domain resource sets;
a quantity of scheduled resource elements, where for example, a frequency domain resource length includes a quantity of REs, a quantity of RBs, and a quantity of RBGs; and
an actual bandwidth.

A start location of the resource set may include at least one of a time domain start location (Toffset) or a frequency domain start location (Foffset), for example, a time domain start location or a frequency domain start location shown in FIG. 6.

In some implementations, both the time domain start location and the frequency domain start location are default values. For example, both the time domain start location and the frequency domain start location are 0 by default, that is, the frequency domain start location is the first RE in an RB, and the time domain start location is the first symbol in a slot.

The resource difference between the neighboring resource sets may be a time domain difference or a frequency domain difference between the neighboring resource sets.

In this implementation, the time-frequency resource pattern may be configured in more detail and accurately by using the parameter information of the time-frequency resource pattern.

It should be noted that all or a part of the time domain resource length information, the frequency domain resource length information, the start location of the resource set, and the resource difference between the neighboring resource sets may be default or agreed in a protocol or configured by a network side.

In addition, the implementation may also be combined with the implementation of the index information of the resource set and the parameter information of the resource set, or implemented separately. For example, the first configuration information may include at least one of the index information of the resource set or the parameter information of the resource set, or may include or not include at least one of the index information of the time-frequency resource pattern or the parameter information of the time-frequency resource pattern.

In this way, design of two levels of sensing signal resource patterns can be implemented, that is, a first-level pattern (a pattern in the sensing signal resource set), and a second-level pattern (a time-frequency domain pattern that uses a sensing signal resource set as a basic unit) can be used. A maximum unambiguous measurement range requirement can be ensured by using the design of the first-level pattern, and a sensing resolution requirement can be ensured by using the design of the second-level pattern.

Optionally, the resource difference between the neighboring resource sets includes at least one of the following:
a frequency domain difference between start frequency domain resources of the neighboring resource sets, or a minimum frequency domain difference between the neighboring resource sets; and
a time domain difference between start time domain resources of the neighboring resource sets, or a minimum time domain difference between the neighboring resource sets.

The frequency domain difference between the start frequency domain resources of the neighboring resource sets may be the frequency domain difference between the start frequency domain resources of the neighboring resource sets. For example, as shown in FIG. 4, the frequency domain difference between the start frequency domain resources of the neighboring resource sets is Δf2.

The time domain difference between the start time domain resources of the neighboring resource sets may be the time domain difference between the start time domain resources of the neighboring resource sets. For example, as shown in FIG. 4, the time domain difference between the start time domain resources of the neighboring resource sets is ΔT2.

In addition, the frequency domain difference between the start frequency domain resources of the neighboring resource sets may also be a frequency domain difference between frequency domain resource elements at a same frequency domain location in the neighboring resource sets. In addition, the time domain difference between the start time domain resources of the neighboring resource sets may also be a time domain difference between time domain resource elements at a same time domain location in the neighboring resource sets.

The minimum frequency domain difference between the neighboring resource sets may be a frequency domain difference between a last frequency domain resource element of a previous resource set and a first frequency domain resource element of a subsequent resource set. For example, as shown in FIG. 7, the minimum frequency domain difference between the neighboring resource sets is Δf2′.

The minimum time domain difference between the neighboring resource sets may be a time domain difference between a last time domain resource element of a previous resource set and a first time domain resource element of a subsequent resource set. For example, as shown in FIG. 7, the minimum time domain difference between the neighboring resource sets is ΔT2′.

In the foregoing implementation, more flexible configuration of the time-frequency resource pattern may be supported by using different resource differences, which helps improve sensing measurement performance.

Optionally, the resource difference between the neighboring resource sets is represented in the following manner:
a resource density, a time domain period, a frequency domain period, a time domain index, or a frequency domain index.

The resource density may represent a quantity of resource sets in a single RB or Slot, or another resource element. A time domain resource density and a frequency domain resource density may be the same, for example, both densities are 1 by default. Alternatively, the time domain resource density and the frequency domain resource density are different, including a time domain resource density T_density and a frequency domain resource density F_density.

The time domain period may be a period in units of symbols, slots, subframes, half-frames, or frames, and the frequency domain period may be a frequency domain period in units of REs or RBs.

The time domain index may be an index of a first time domain resource element in the resource set. For example, as shown in FIG. 7, time domain indexes of two neighboring resource sets are {0, 7}.

The frequency domain index may be an index of a first frequency domain resource element in the resource set. For example, as shown in FIG. 7, frequency domain indexes of two neighboring resource sets are {0, 6}.

In this implementation, the resource difference between the neighboring resource sets may be indicated by using at least one of the resource density, the time domain period, the frequency domain period, the time domain index, and the frequency domain index, so that overheads of the first configuration information can be saved.

In an optional implementation, the first configuration information is further used to indicate at least one of the following:
a signal identifier of the sensing signal, a waveform of the sensing signal, a subcarrier spacing, signal power of the sensing signal, sequence information of the sensing signal, and a signal direction of the sensing signal.

The signal identifier (ID) may be used to distinguish different signal resources, or is used to indicate that the signal is a sensing signal.

The waveform may be orthogonal frequency division multiplex (OFDM), discrete Fourier transform-spread spectrum-orthogonal frequency division multiplexing (DFT-s-OFDM), single-carrier frequency-division multiple access (SC-FDMA), orthogonal time frequency space (OTFS), frequency modulated continuous wave (FMCW), a pulse signal, or the like.

The subcarrier spacing (SCS) may be a subcarrier spacing of an OFDM system, for example, 30 KHz.

The signal power may be a value taken at intervals of 2 dBm from −20 dBm to 23 dBm, or another power value.

The sequence information may be information about a generation sequence used for the sensing signal, such as a Zadoff-Chu sequence or a pseudo-noise (PN) sequence, and may indicate a generation manner.

The signal direction may be angle information or beam information of sending of the sensing signal.

In this implementation, at least one of the signal identifier, the waveform, the subcarrier spacing, the signal power, the sequence information, and the signal direction that are of the sensing signal is configured, so that transmission reliability of the sensing signal can be further improved.

In an optional implementation, the resource set meets at least one of the following:
a resource difference in the resource set is less than a resource difference between neighboring resource sets; and
the resource elements in the resource set are consecutive, or the resource elements in the resource set are inconsecutive.

That the resource difference in the resource set is less than the resource difference between the neighboring resource sets may be that the resource difference in the resource set is less than a minimum resource difference between the neighboring resource sets. For example, a time domain difference in the resource set is less than a minimum domain difference ΔT2′ between the neighboring resource sets, and a frequency domain difference in the resource set is less than a minimum frequency domain difference Δf2′ between the neighboring resource sets.

In this implementation, because the resource difference in the resource set is less than the resource difference between the neighboring resource sets, the time-frequency resource pattern can better meet the resolution requirement or the unambiguous measurement requirement, thereby further improving sensing performance.

That the resource elements in the resource set are consecutive may be at least one of time domain resource consecutiveness or frequency domain resource consecutiveness. For example, Δf1=SCS described in the foregoing implementation, and ΔT1=OFDM symbol length (Tsymbol) described in the foregoing implementation. In this case, the first configuration information may not include related information of a resource difference between the resource elements in the resource set.

Consecutiveness of the resource elements in the resource set may be more conducive to improving transmission reliability of the sensing signal.

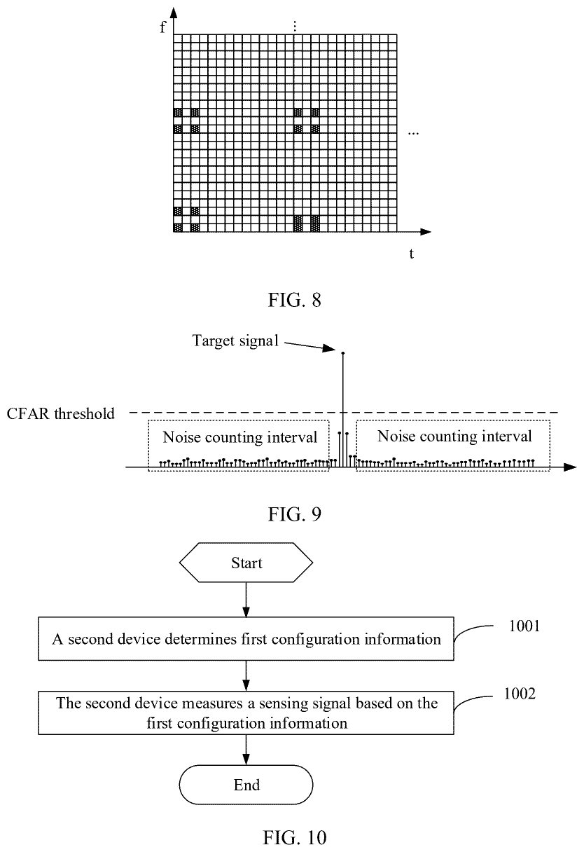

That the resource elements in the resource set are inconsecutive may be at least one of time domain resource inconsecutiveness or frequency domain resource inconsecutiveness. For example, as shown in FIG. 8, time domain resources in the resource set are inconsecutive, and frequency domain resources are inconsecutive.

It should be noted that the time-frequency resource pattern is mainly described by using a time-frequency resource pattern for a single port as an example.

In an optional implementation, a quantity of frequency domain resource elements in the resource set is 2, a quantity of time domain resource elements in the resource set is 2, the two time domain resource elements are consecutive in time domain, and the two frequency domain resource elements are consecutive in frequency domain; or
a quantity of frequency domain resource elements in the resource set is 1, a quantity of time domain resource elements in the resource set is 2, and the two time domain resource elements are consecutive in time domain.

In the first case, the resource set may be the resource sets shown in FIG. 4 to FIG. 6 may be used, and in the second case, the resource set may be the resource set shown in FIG. 7.

In the foregoing implementation, in a case that the quantity of frequency domain resource elements in the resource set is 2, the quantity of time domain resource elements in the resource set is 2, the two time domain resource elements are consecutive in time domain, and the two frequency domain resource elements are consecutive in frequency domain, in a given subcarrier spacing configuration, an unambiguous measurement range requirement can be ensured as far as possible and sensing resource overheads are low.

In the foregoing implementation, in a case that the quantity of frequency domain resource elements in the resource set is 1, the quantity of time domain resource elements in the resource set is 2, and the two time domain resource elements are consecutive in a time domain, in a given subcarrier spacing configuration, an unambiguous velocity or Doppler measurement range requirement can be ensured as far as possible and sensing resource overheads are low. An unambiguous delay or distance measurement range can be ensured by adjusting an interval or a density between frequency domain resource sets.

In an optional implementation, in a case that the sensing signal is configured for a plurality of ports, resources of the sensing signal are multiplexed on different ports, and the multiplexing includes at least one of time division multiplexing and frequency division multiplexing; or
in a case that the sensing signal is configured for a plurality of ports and resources of the sensing signal on different ports are the same, generation sequences of the sensing signal on different ports are different.

In this implementation, the sensing signal may be configured for transmission through a plurality of ports, and a plurality of multiplexing manners may exist, such as time division multiplexing of a resource pattern on different ports or frequency division multiplexing of a resource pattern on different ports, which helps improve transmission reliability of the sensing signal.

In addition, in a case that resources of the sensing signal on different ports are the same, generation sequences of the sensing signal on different ports are different. In this way, the sensing signal can be transmitted on a same resource on different ports, thereby saving transmission resources.

In an optional implementation, the determining, by a first device, first configuration information includes:
determining, by the first device, the first configuration information based on sensing requirement information; or
receiving, by the first device, the first configuration information sent by a third device.

The sensing requirement information may be generated by the first device, or may be received by the first device and sent by another device.

In some implementations, the sensing requirement information may include at least one of the following:
a sensing service, where sensing services may be classified based on a type or specified to a service, for example, environment reconstruction, respiration or heartbeat detection, positioning or track tracing, action identification, weather monitoring, radar ranging, radar velocity measurement, or radar angle measurement;
a sensing target region, where the sensing target region is a location region in which a sensing object may exist, or a location region in which imaging or environment reconstruction needs to be performed;
a sensing object type, where the sensing object type may be obtained by classifying a sensing object based on a possible motion characteristic of the sensing object, where each sensing object type includes information such as a motion velocity, a motion acceleration, and a typical radar cross section (RCS) of a typical sensing object; and
sensing quality of service (QoS), where sensing QoS may be a performance indicator for sensing a sensing target region or a sensing object, including at least one of the following:
a sensing resolution, where the sensing resolution may be further divided into a distance resolution, a delay resolution, an angle resolution, a velocity/Doppler resolution, an imaging resolution, and the like;
sensing precision, where the sensing precision may be further divided into distance precision, delay precision, angle precision, velocity/Doppler precision, positioning precision, and the like;
a sensing range, where the sensing range may be further divided into a distance range, a delay range, a velocity range, a Doppler range, an angle range, an imaging range, and the like;
a sensing delay, where the sensing delay may be a time interval from sending of a sensing signal to obtaining of a sensing result, or a time interval from initiating of a sensing requirement to obtaining of a sensing result;
a sensing update rate, where the sensing update rate may be a time interval between two consecutive times of performing sensing and obtaining a sensing result;
a detection probability, where the detection probability may be a probability that a sensing object is correctly detected in a case that the sensing object exists;
a false alarm probability, where the false alarm probability may be a probability that a sensing object is incorrectly detected in a case that the sensing target does not exist; and
a maximum quantity of targets that can be sensed.

The determining, by the first device, the first configuration information based on sensing requirement information may be determining the first configuration information that matches the sensing requirement information or the first configuration information that meets a sensing requirement.

The first configuration information is determined based on the sensing requirement information, so that the configured time-frequency resource pattern can meet the sensing requirement information, thereby improving sensing performance.

The third device may include at least one of the following: a core network-sensing network function, a base station, and another terminal.

In an optional implementation, the sending the sensing signal includes: sending the sensing signal to a second device.

Alternatively, the method further includes:
receiving, by the first device, an echo signal of the sensing signal, and performing measurement based on the echo signal.

The second device may be a terminal or a network side device.

In this implementation, sensing measurement may be performed by the second device, or sensing measurement may be performed by the first device.

Optionally, the method further includes at least one of the following:
sending, by the first device, at least one of the first configuration information or second configuration information to the second device in a case that the sensing signal is sent to the second device; or
obtaining, by the first device, second configuration information in a case that the first device receives the echo signal of the sensing signal and performs measurement based on the echo signal.

The obtaining, by the first device, second configuration information may be that the first device receives the second configuration information sent by the second device or the third device.

The second configuration information may be used to configure at least one of the following:
measurement information and measurement result reporting information.

The measurement information may include a sensing measurement quantity.

The sensing measurement quantity may include the following four types:
a first-level measurement quantity, such as received signal information or original channel information, which may include at least one of the following:
a response complex result of a received signal or channel, an amplitude or a phase of the received signal or channel, an I-channel result or a Q-channel result of the received signal or channel; and
results of operations related to at least one of the foregoing items, where
the operations include addition, subtraction, multiplication, and division, matrix addition, subtraction, and multiplication, matrix transposition, a trigonometric operation, a square root operation, a power operation, and the like, along with a threshold detection result, a maximum/minimum value extraction result, and the like of results of the foregoing operations; and the operations further include fast Fourier transform (FFT)/inverse fast Fourier transform (IFFT), discrete Fourier transform (DFT)/inverse discrete Fourier transform (IDFT), 2D-FFT, 3D-FFT, matched filtering, an autocorrelation operation, wavelet transform, digital filtering, and the like, along with a threshold detection result, a maximum/minimum value extraction result, and the like of results of the foregoing operations;
a second-level measurement quantity, such as a basic measurement quantity, which may include at least one of the following:
a delay, a Doppler, an angle, and intensity; and
a combination representation of at least one of the foregoing items;
a third-level measurement quantity, such as a basic attribute and/or status, which may include at least one of the following:
a distance, a velocity, an orientation, a spatial location, and an acceleration; and
a fourth-level measurement quantity, such as a progressive attribute and/or status, which may include at least one of the following:
whether a target exists, a track, an action, an expression, a vital sign, a quantity, an imaging result, weather, air quality, a shape, a material, and a component.

The measurement result reporting information may include at least one of the following:
a resource configuration for measurement result reporting;
a time domain measurement result reporting behavior; and
a trigger condition for measurement result reporting.

The resource configuration for measurement result reporting may include a frequency domain resource configuration or a time domain resource configuration for measurement result reporting.

The time domain measurement result reporting behavior may include periodic reporting, semi-persistent reporting, or aperiodic reporting.

The periodic reporting may be performing reporting based on a specified time offset or period.

The semi-persistent reporting may be as follows: After a reporting start indication is received, reporting is performed based on a specified period until a reporting stop indication is received. The reporting start indication is used to indicate a start of corresponding sensing reporting, and the reporting stop indication is used to indication to stop reporting.

The aperiodic reporting may be performing reporting at a specified moment or in a case that a preset condition is met.

The trigger condition for reporting may be that a sensing measurement result or sensing performance corresponding to the sensing measurement result meets a preset condition. For example, the sensing measurement result meets a preset interval range, or a power value of a sensing target associated signal component meets a preset threshold.

Through the second configuration information, measurement can be better performed between devices, and a measurement result can be better reported.

In addition, the first configuration information is sent to the second device, and the second device may directly measure the sensing signal based on the first configuration information, to improve measurement performance.

In an implementation, before the first device sends the sensing signal to the second device, the second device determines the first configuration information, or the second device obtains the sensing requirement information. That the second device determines the first configuration information or the sensing requirement information may be that the first device sends the first configuration information or the sensing requirement information to the second device, or the third device sends the first configuration information or the sensing requirement information to the second device.

In this implementation, before the first device sends the sensing signal to the second device, the first device obtains the first configuration information, or the first device obtains the sensing requirement information. That the first device obtains the first configuration information or the sensing requirement information may be that the second device sends the first configuration information or the sensing requirement information to the first device, or the third device sends the first configuration information or the sensing requirement information to the first device.

In another implementation, before the first device sends the sensing signal and receives an echo for measurement, the first device obtains the first configuration information, or the first device obtains the sensing requirement information. That the first device obtains the first configuration information or the sensing requirement information may be that the third device sends the first configuration information or the sensing requirement information to the first device.

In an optional implementation, the method further includes at least one of the following:
in a case that the sensing signal is sent to the second device, receiving, by the first device, a measurement result sent by the second device; and
sending, by the first device, a measurement result to the third device in a case that the first device receives the echo signal of the sensing signal and performs measurement based on the echo signal.

In this implementation, the second device may receive the sensing signal based on the first configuration information, or the second device may determine the first configuration information based on the sensing requirement information, receive and measure the sensing signal based on the determining first configuration information, and feed back the measurement result to the first device or the third device.

Alternatively, the first device may receive and measure the sensing signal sent by the first device, and feed back the measurement result to the third device.

The measurement result may include at least one of the following:
a first delay calculated based on a sensing signal in the resource set;
a first Doppler calculated based on the sensing signal in the resource set;
first phase difference information calculated based on the sensing signal in the resource set;
a second delay calculated based on a sensing signal between a plurality of resource sets;
a second Doppler calculated based on the sensing signal between the plurality of the resource sets;
a third delay calculated based on the first delay and the second delay;
a distance calculated based on the first delay and the second delay;
a third Doppler calculated based on the first Doppler and the second Doppler;
a velocity calculated based on the first Doppler and the second Doppler; and
a sensing performance indicator.

The first delay may be a composite delay value calculated based on the sensing signal in the resource set.

The first Doppler may be a composite Doppler value calculated based on the sensing signal in the resource set.

The first phase difference information may be phase difference information between different resource elements that is calculated based on the sensing signal in the resource set, including frequency domain phase difference information and time domain phase difference information.

The second delay may be a delay value calculated based on a sensing signal between resource sets.

The second Doppler may be a Doppler value calculated based on a sensing signal between resource sets.

The third delay may be a target delay value calculated based on the first delay and the second delay.

The distance calculated based on the first delay and the second delay may be a target distance calculated based on the first delay and the second delay.

The third Doppler may be a target Doppler value calculated based on the first Doppler and the second Doppler.

The velocity calculated based on the first Doppler and the second Doppler may be a target velocity calculated based on the first Doppler and the second Doppler.

The target delay, the target distance, the target Doppler, and the target velocity may be an actual delay, distance, Doppler, and velocity that correspond to a last calculated sensing target.

The sensing performance indicator may include at least one of the following:
sensing signal to noise ratio (SNR) and sensing signal to interference plus noise ratio (SINR).

The sensing SNR may be a ratio of sensing target associated signal power to noise power, and the sensing SINR may be a ratio of the sensing target associated signal power to a sum of the power noise and interference power.

Using radar detection as an example, the method for obtaining the sensing target associated signal power may be at least one of the following options:

Constant false alarm rate (CFAR) is performed based on a one-dimensional delay map obtained through fast-time dimension fast Fourier Transform (FFT) processing of an echo signal, a sample value point with a maximum amplitude whose CFAR exceeds a threshold is used as a target sample value point, and the amplitude of the target sample value point is used as a target signal amplitude to calculate the sensing target associated signal power, as shown in FIG. 9.

CFAR is performed based on a one-dimensional Doppler map obtained through slow-time dimension FFT processing of an echo signal, and a sample value point with a maximum amplitude whose CFAR exceeds a threshold is used as a target sample value point, and the amplitude of the target sample value point is used as a target signal amplitude to calculate the sensing target associated signal power, also as shown in FIG. 9.

CFAR is performed based on a two-dimensional Doppler map obtained through 2D-FFT processing of an echo signal, and a sample value point with a maximum amplitude whose CFAR exceeds a threshold is used as a target sample value point, and the amplitude of the target sample value point is used as a target signal amplitude to calculate the sensing target associated signal power.

CFAR is performed based on a three-dimensional delay-Doppler-angle map obtained through 3D-FFT processing of an echo signal, and a sample value point with a maximum amplitude whose CFAR exceeds a threshold is used as a target sample value point, and the amplitude of the target sample value point is used as a target signal amplitude to calculate the sensing target associated signal power.

In addition to using the sample value point with the maximum amplitude whose CFAR exceeds the threshold as the target sample value point, a method for determining the target signal amplitude may be using an average value of the sample value point with the maximum amplitude whose CFAR exceeds the threshold and several nearest sample value points exceeding the threshold as the target signal amplitude to calculate the sensing target associated signal power.

A method for obtaining an SNR/SINR of the echo signal may be at least one of the following options:

CFAR is performed based on a one-dimensional delay map obtained through fast-time dimension FFT processing of the echo signal, a sample value point with a maximum amplitude whose CFAR exceeds a threshold is used as a target sample value point, the amplitude of the target sample value point is used as a target signal amplitude, all sample value points different from those ±ε sample value points away from a location of the target sample value point in the one-dimensional map are used as interference/noise sample value points, and an average interference/amplitude of the interference/noise sample value points is counted as an interference/noise signal amplitude, as shown in FIG. 9. Finally, the SNR/SINR is calculated by using the target signal amplitude and the interference/noise signal amplitude.

CFAR is performed based on a one-dimensional Doppler map obtained through slow-time dimension FFT processing of the echo signal, a sample value point with a largest amplitude whose CFAR exceeds a threshold is used as a target sample value point, an amplitude of the target sample value point is used as a target signal amplitude, all sample value points different from those ±η sample value points away from a location of the target sample value point in the one-dimensional map are used as interference/noise sample value points, and an average amplitude of the interference/noise sample value points is counted as an interference/noise signal amplitude. Finally, the SNR/SINR is calculated by using the target signal amplitude and the interference/noise signal amplitude.

CFAR is performed based on a two-dimensional delay-Doppler map obtained through 2D-FFT processing of the echo signal, a sample value point with a maximum amplitude whose CFAR exceeds a threshold is used as a target sample value point, the amplitude of the target sample value point is used as a target signal amplitude, all sample value points different from those ±ε (a fast-time dimension) and ±η (a slow-time dimension) sample value points away from the target sample value point in the two-dimensional map are used as interference/noise sample value points, and an average amplitude of the interference/noise sample value points is counted as an interference/noise signal amplitude. Finally, the SNR/SINR is calculated by using the target signal amplitude and the interference/noise signal amplitude.

CFAR is performed based on a three-dimensional delay-Doppler-angle map obtained through 3D-FFT processing of the echo signal, a sample value point with a maximum amplitude whose CFAR exceeds a threshold is used as a target sample value point, the amplitude of the target sample value point is used as a target signal amplitude, all sample value points different from those ±ε (a fast-time dimension), ±η (a slow-time dimension), and ±δ (an angle dimension) sample value points away from the target sample value point in the three-dimensional map are used as interference/noise sample value points, and an average amplitude of the interference/noise sample value points is counted as an interference/noise signal amplitude. Finally, the SNR/SINR is calculated by using the target signal amplitude and the interference/noise signal amplitude.

In addition to using the sample value point with the maximum amplitude whose CFAR exceeds the threshold as the target sample value point, a method for determining the target signal amplitude may be using an average value of the sample value point with the maximum amplitude whose CFAR exceeds the threshold and several nearest sample value points exceeding the threshold as the target signal amplitude.

A method for determining an interference/noise sample value point may alternatively be performing further selection based on the determined interference/noise sample value points. A selection method is as follows: For the one-dimensional delay map, several sample value points near a delay of 0 are removed, and remaining interference/noise sample value points are used as noise sample value points; for the one-dimensional Doppler map, several sample value points near Doppler of 0 are removed, and remaining interference/noise sample value points are used as interference/noise sample value points; for the two-dimensional delay-Doppler map, several points near a delay of 0 and interference/noise sample value points in a strip range formed by all Doppler ranges are removed, and remaining noise sample value points are used as interference/noise sample value points; or for the three-dimensional delay-Doppler-angle map, several points near a time dimension of 0 and interference/noise sample value points in a slice range formed by all Doppler ranges and all angle ranges are removed, and remaining interference/noise sample value points are used as interference/noise sample value points.

In the foregoing implementation, a plurality of measurement manners and a plurality of measurement results are supported, to further improve sensing measurement performance.

In an optional implementation, in this embodiment of this application, the first device includes a network side device, the second device includes a terminal, and the third device includes at least one of the following: a core network-sensing network function, a network side device, or a terminal;
the first device includes a network side device, and the third device includes at least one of the following: a core network-sensing network function, a network side device, or a terminal;
the first device includes a network side device, the second device includes a network side device, and the third device includes at least one of the following: a core network-sensing network function, a network side device, or a terminal;
the first device includes a terminal, the second device includes a network side device, and the third device includes at least one of the following: a core network-sensing network function, a network side device, or a terminal;
the first device includes a terminal, the second device includes a terminal, and the third device includes at least one of the following: a core network-sensing network function, a network side device, or a terminal; or
the first device includes a terminal, and the third device includes at least one of the following: a core network-sensing network function, a network side device, or a terminal.

The foregoing implementation may be specifically applied to at least one scenario.

Scenario 1: The first device is a base station, and the second device is a terminal. The base station sends a sensing signal, the terminal receives and measures the sensing signal, and the terminal sends a measurement result to the base station or the third device, where the third device may be a core network-sensing network function or another base station, or terminal.

Before the terminal receives the sensing signal, the third device or the base station sends at least one of the first configuration information, the sensing requirement information, and the measurement or reporting configuration information to the terminal.

Before the base station sends the sensing signal, the third device sends the first configuration information, the sensing requirement information, and/or the measurement/reporting configuration information to the base station.

Scenario 2: The first device is a base station, and the base station independently sends and receives a sensing signal and measures the sensing signal, and sends a measurement result to the third device, where the third device may be a core network-sensing network function or another base station or terminal.

Before the base station sends the sensing signal, the third device sends at least one of the first configuration information, the sensing requirement information, and the measurement or reporting configuration information to the base station.

Scenario 3: The first device is a base station A, and the second device is a base station B. The base station A sends a sensing signal, the base station B receives and measures the sensing signal, and the base station B sends a measurement result to the base station A or the third device, where the third device may be a core network-sensing network function or another base station or terminal.

Before the base station B receives the sensing signal, the base station A or the third device sends at least one of the first configuration information, the sensing requirement information, and the measurement or reporting configuration information to the base station B.

Before the base station A sends the sensing signal, the base station B or the third device sends at least one of the first configuration information, the sensing requirement information, and the measurement or reporting configuration information to the base station A.

Scenario 4: The first device is a terminal, and the second device is a base station. The terminal sends a sensing signal, the base station receives and measures the sensing signal, and sends a measurement result to the terminal or the third device, where the third device may be a core network-sensing network function, another base station, or another terminal.

Before the base station receives the sensing signal, the terminal or the third device sends at least one of the first configuration information, the sensing requirement information, and the measurement or reporting configuration information to the base station.

Before the terminal sends the sensing signal, the base station or the third device sends the first configuration information, the sensing requirement information, and/or the measurement/reporting configuration information to the terminal.

Scenario 5: The first device is a terminal A, and the second device is a terminal B. The terminal A sends a sensing signal, the terminal B receives and measures the sensing signal, and the terminal B sends a measurement result to the terminal A or the third device, where the third device may be a core network-sensing network function, a base station, or another terminal.

Before the terminal B receives the sensing signal, the terminal A or the third device sends at least one of the first configuration information, the sensing requirement information, and the measurement or reporting configuration information to the terminal B.

Before the terminal A sends the sensing signal, the terminal B or the third device sends at least one of the first configuration information, the sensing requirement information, and the measurement or reporting configuration information to the terminal.

Scenario 6: The first device is a terminal, and the terminal independently sends and receives a sensing signal and measures the sensing signal, and sends a measurement result to the third device, where the third device may be a core network-sensing network function, a base station, or another terminal.

Before the terminal sends the sensing signal, the third device sends at least one of the first configuration information, the sensing requirement information, and the measurement or reporting configuration information to the base station.

In this embodiment of this application, the sensing network function may also be referred to as a sensing network element or a sensing management function (Sensing MF), and may be located on a RAN side or a core network side. The sensing network function refers to a network node that is in a core network or in a RAN and that is responsible for at least one function of sensing request processing, sensing resource scheduling, sensing information exchange, sensing data processing, and the like. The sensing network function may be upgraded based on an AMF or an LMF in a 5G network, or may be another network node or a newly defined network node. Specifically, a function feature of the sensing network function/sensing network element may include at least one of the following:

Target information is exchanged with a wireless signal sending device and/or a wireless signal measurement device (including a target terminal, a serving base station of a target terminal, or a base station associated with a target region), where the target information includes a sensing processing request, a sensing capability, sensing-assisted data, a sensing measurement quantity type, sensing resource configuration information, and the like, to obtain a target sensing result or a value of a sensing measurement quantity (an uplink measurement quantity or a downlink measurement quantity) sent by the wireless signal measurement device. A wireless signal may also be referred to as a sensing signal.

A sensing method to be used is determined based on factors such as a type of a sensing service, sensing service consumer information, required sensing QoS requirement information, a sensing capability of the wireless signal sending device, and a sensing capability of the wireless signal measurement device. The sensing method may include: A base station A performs sending and a base station B performs receiving, a base station performs sending and a terminal performs receiving, the base station A independently performs sending and independently performs receiving, a terminal performs sending and a base station performs receiving, a terminal independently performs sending and independently performs receiving, a terminal A performs sending and a terminal B performs receiving, or the like.

A sensing device for serving the sensing service is determined based on factors such as the type of the sensing service, the sensing service consumer information, the required sensing QoS requirement information, the sensing capability of the wireless signal sending device, and the sensing capability of the wireless signal measurement device, where the sensing device includes the wireless signal sending device and/or the wireless signal measurement device.

Overall coordination and scheduling of resources required for the sensing service are managed. For example, sensing resources of the base station and/or the terminal are correspondingly configured.

Data processing is performed on the value of the sensing measurement quantity, or calculation is performed to obtain a sensing result. Further, the sensing result is verified, sensing precision is estimated, and so on.

In the embodiments of this application, the first device determines the first configuration information, where the first configuration information is used to configure the time-frequency resource pattern of the sensing signal, the time-frequency resource pattern includes at least one resource set used to transmit the sensing signal, and the resource set includes at least two time domain resource elements and at least one frequency domain resource element. The first device sends the sensing signal based on the time-frequency resource pattern. In this way, the sensing signal can be sent based on the time-frequency resource pattern configured for the sensing signal, so that transmission reliability of the sensing signal can be improved, thereby improving sensing measurement performance.

Referring to FIG. 10, FIG. 10 is a flowchart of a sensing signal measurement method according to an embodiment of this application. As shown in FIG. 10, the method includes the following steps.

Step 1001: A second device determines first configuration information, where the first configuration information is used to configure a time-frequency resource pattern of a sensing signal, the time-frequency resource pattern includes at least one resource set used to transmit the sensing signal, and the resource set includes at least two time domain resource elements and at least one frequency domain resource element.

Step 1002: The second device measures the sensing signal based on the first configuration information.

Optionally, the determining, by a second device, first configuration information includes:
receiving, by the second device, the first configuration information sent by a first device, where the sensing signal is sent by the first device;
receiving, by the second device, the first configuration information sent by a third device; or
determining, by the second device, the first configuration information based on sensing requirement information.

Optionally, the sensing signal is used for at least one of the following:
velocity estimation, Doppler estimation, distance estimation, delay estimation, and angle estimation.

Optionally, the resource set meets an unambiguous measurement requirement.

Optionally, a time domain difference between neighboring time domain resource elements in the resource set meets at least one of the following: an unambiguous Doppler measurement requirement and an unambiguous velocity measurement requirement; or
a time domain density in the resource set meets at least one of the following: an unambiguous Doppler measurement requirement and an unambiguous velocity measurement requirement.

Optionally, a frequency domain difference between neighboring frequency domain resource elements in the resource set meets at least one of the following: an unambiguous delay measurement requirement and an unambiguous distance measurement requirement; or
a frequency domain density in the resource set meets at least one of the following: an unambiguous delay measurement requirement and an unambiguous distance measurement requirement.

Optionally, the first configuration information includes at least one of the following:
index information of the resource set; and
parameter information of the resource set.

Optionally, the parameter information of the resource set includes at least one of the following:
a quantity of resource elements in the resource set, the time domain difference between the neighboring time domain resource elements in the resource set, the time domain density in the resource set, the frequency domain difference between the neighboring frequency domain resource elements in the resource set, and the frequency domain density in the resource set.

Optionally, the time-frequency resource pattern meets a resolution requirement.

Optionally, a time domain resource length of the time-frequency resource pattern meets at least one of the following: a Doppler resolution requirement and a velocity resolution requirement.

Optionally, a frequency domain resource length of the time-frequency resource pattern meets at least one of the following: a delay resolution requirement and a distance resolution requirement.

Optionally, the first configuration information includes at least one of the following:
index information of the time-frequency resource pattern; and
parameter information of the time-frequency resource pattern.

Optionally, the parameter information of the time-frequency resource pattern includes at least one of the following:
time domain resource length information, frequency domain resource length information, a start location of the resource set, and a resource difference between neighboring resource sets.

Optionally, the resource difference between the neighboring resource sets includes at least one of the following:
a frequency domain difference between start frequency domain resources of the neighboring resource sets, or a minimum frequency domain difference between the neighboring resource sets; and
a time domain difference between start time domain resources of the neighboring resource sets, or a minimum time domain difference between the neighboring resource sets.

Optionally, the resource difference between the neighboring resource sets is represented in the following manner:
a resource density, a time domain period, a frequency domain period, a time domain index, or a frequency domain index.

Optionally, the first configuration information is further used to indicate at least one of the following:
a signal identifier of the sensing signal, a waveform of the sensing signal, a subcarrier spacing, signal power of the sensing signal, sequence information of the sensing signal, and a signal direction of the sensing signal.

Optionally, the resource set meets at least one of the following:
a resource difference in the resource set is less than a resource difference between neighboring resource sets; and
the resource elements in the resource set are consecutive, or the resource elements in the resource set are inconsecutive.

Optionally, a quantity of frequency domain resource elements in the resource set is 2, a quantity of time domain resource elements in the resource set is 2, the two time domain resource elements are consecutive in time domain, and the two frequency domain resource elements are consecutive in frequency domain; or
a quantity of frequency domain resource elements in the resource set is 1, a quantity of time domain resource elements in the resource set is 2, and the two time domain resource elements are consecutive in time domain.

Optionally, the sensing signal includes:
a signal generated based on at least one of an M sequence, a Gold sequence, a Kasami sequence, a Golay sequence, and a Zadoff-Chu sequence;
communication data;
a radar signal; or
an integrated communication and sensing signal.

Optionally, in a case that the sensing signal is configured for a plurality of ports, resources of the sensing signal are multiplexed on different ports, and the multiplexing includes at least one of time division multiplexing and frequency division multiplexing; or
in a case that the sensing signal is configured for a plurality of ports and resources of the sensing signal on different ports are the same, generation sequences of the sensing signal on different ports are different.

Optionally, the method further includes:
receiving, by the second device, second configuration information sent by the first device.

The second configuration information is used to configure at least one of the following:
measurement information and measurement result reporting information.

The measurement information includes a sensing measurement quantity.

The measurement result reporting information includes at least one of the following:
a resource configuration for measurement result reporting;
a time domain measurement result reporting behavior; and
a trigger condition for measurement result reporting.

Optionally, the time domain measurement result reporting behavior includes:
periodic reporting, semi-persistent reporting, or aperiodic reporting.

Optionally, the method further includes at least one of the following:
sending, by the second device, a measurement result to the first device.

The measurement result includes at least one of the following:
a first delay calculated based on a sensing signal in the resource set;
a first Doppler calculated based on the sensing signal in the resource set;
first phase difference information calculated based on the sensing signal in the resource set;
a second delay calculated based on a sensing signal between a plurality of resource sets;
a second Doppler calculated based on the sensing signal between the plurality of the resource sets;
a third delay calculated based on the first delay and the second delay;
a distance calculated based on the first delay and the second delay;
a third Doppler calculated based on the first Doppler and the second Doppler;
a velocity calculated based on the first Doppler and the second Doppler; and
a sensing performance indicator.

Optionally, the first device includes a network side device, the second device includes a terminal, and the third device includes at least one of the following: a core network-sensing network function, a network side device, or a terminal;
the first device includes a network side device, and the third device includes at least one of the following: a core network-sensing network function, a network side device, or a terminal;
the first device includes a network side device, the second device includes a network side device, and the third device includes at least one of the following: a core network-sensing network function, a network side device, or a terminal;
the first device includes a terminal, the second device includes a network side device, and the third device includes at least one of the following: a core network-sensing network function, a network side device, or a terminal;
the first device includes a terminal, the second device includes a terminal, and the third device includes at least one of the following: a core network-sensing network function, a network side device, or a terminal; or
the first device includes a terminal, and the third device includes at least one of the following: a core network-sensing network function, a network side device, or a terminal.

It should be noted that this embodiment is used as an implementation corresponding to the second device in the embodiment shown in FIG. 3. For a specific implementation of this embodiment, refer to related descriptions of the embodiment shown in FIG. 3. To avoid repetition, details are not described in this embodiment.

The following uses a plurality of embodiments to illustrate the method provided in embodiments of this application.

### Embodiment 1

In this embodiment, a typical time-frequency domain pattern design of a sensing signal is mainly used as an example for description. Details are as follows:

To support an unambiguous measurement range and a resolution requirement in a sensing signal design, and reduce sensing signal overheads as much as possible, this embodiment provides two typical time-frequency domain pattern designs in consecutive resource mapping.

A pattern design 1 is shown in FIG. 4, that is, a first-level pattern (a pattern in a resource set of the sensing signal), and has at least one of the following features:

A resource set size is 4, that is, four time-frequency domain resource elements form a resource set, where a quantity of time domain resources=a quantity of frequency domain resources=2.

The time domain resources and the frequency domain resources in the resource set are consecutive, that is, a frequency domain difference between frequency domain resource elements in the set is Δf1=SCS (subcarrier spacing), and a time domain difference between time domain resource elements in the set is ΔT1=Tsymbol (OFDM symbol length).

It should be noted that, in some cases, the frequency domain difference between the frequency domain resource elements in the set may also be referred to as a frequency domain resource element interval in the set, and the time domain difference between the time domain resource elements in the set may also be referred to as a time domain resource element interval in the set.

Advantages of the foregoing pattern features lie in the following: In a given subcarrier spacing configuration, an unambiguous measurement range requirement can be ensured as far as possible, and sensing resource overheads are low. A second-level pattern design may be determined based on parameters associated with a second-level pattern that are provided in the foregoing embodiment.

It should be noted that the foregoing time-frequency resource pattern design of the sensing signal is a design for a single port. For a multi-port sensing signal configuration, time division multiplexing and/or frequency division multiplexing may be used, or code division multiplexing may be used, that is, time-frequency domain resource patterns corresponding to the sensing signal are the same on different ports, but different sequences are used. For example, the sensing signal is generated based on a ZC sequence, and ZC sequences with different root sequence numbers are used for the sensing signal on different ports. It should be noted that, to make full use of channel information of a resource element in the resource set, a code division multiplexing (CDM) design in the resource set is not used for the sensing signal during multi-port code division multiplexing.

To facilitate power allocation between different reference signals and data, and ensure an unambiguous velocity/Doppler measurement range requirement in time domain, a signal resource pattern design with uniform frequency domain distribution is considered, that is, a pattern design 2 shown in FIG. 7. A corresponding first-level pattern (a pattern in a resource set of the sensing signal) has at least one of the following features:

A resource set size of the sensing signal is 2, that is, two time-frequency domain resource elements form a resource set, where a quantity of time domain resources=2, and a quantity of frequency domain resources=1. Alternatively, this may be extended to the following: In the resource set of the sensing signal, a quantity of frequency domain resource elements=1, and a quantity of time domain resources≥2.

The time domain resources in the resource set of the sensing signal are consecutive, that is, a time domain resource element interval in the set is ΔT1=Tsymbol (OFDM symbol length).

Advantages of the foregoing pattern features lie in the following: In a given subcarrier spacing configuration, an unambiguous velocity or Doppler measurement range requirement can be ensured as far as possible, and sensing resource overheads are low. An unambiguous delay/distance measurement range requirement can be ensured by adjusting an interval/density between frequency domain resource sets. The second-level pattern design may be determined based on parameters in a second-level pattern in a solution (2-d) of the present invention.

In addition, for a pattern design in inconsecutive resource mapping in the set, as shown in FIG. 8, a basic idea and a method are similar to those of the pattern design in consecutive resource mapping in the set, and details are not described herein again. A main difference lies in the following: Signal configuration information may not include an intra-set resource interval parameter during consecutive resource mapping, the signal configuration information needs to include the intra-set resource interval parameter during inconsecutive resource mapping, and an intra-set resource interval (inconsecutive)<minimum intra-set resource interval. Compared with that in the consecutive mapping manner, the pattern design in the inconsecutive mapping manner is more flexible.

### Embodiment 2

This embodiment mainly describes a method for configuring a sensing signal. The sensing signal may be specifically configured by using the following several methods:

Manner 1: The sensing signal is configured by using parameters (that is, parameter information in a resource set) associated with a first-level resource pattern and parameters (that is, parameter information of a time-frequency resource pattern) associated with a second-level resource pattern, or the sensing signal may be configured in combination with parameters related to other sensing signal configuration information. For specific content of the parameters, refer to corresponding descriptions in the foregoing embodiment. Details are not described herein again.

Manner 2: At least one typical first-level resource pattern (that is, a pattern in a resource set) is preset, and the sensing signal is configured by using an index (that is, index information in the resource set) of the first-level resource pattern and resource parameters (a start resource location, a time-frequency domain offset, a resource value or density between resource sets, and a total resource length) associated with a second-level resource pattern (that is, the time-frequency resource pattern).

Manner 3: At least one typical first-level resource pattern and some (or all) of resource parameters associated with a second-level resource pattern are preset, and corresponding to different indexes, the sensing signal is indicated by using the indexes and other parameters related to the second-level resource pattern. For example, frequency domain resource densities in parameters associated with the first-level resource pattern and the second-level resource pattern are preset, and may be determined by using an index. The start resource location, the time-frequency domain offset, the resource length (a bandwidth and duration), and a time domain resource density (time domain period) in the parameters associated with the second-level resource pattern are determined based on a parameter.

Manner 4: The sensing signal is configured by using sensing requirement information, for example, different sensing measurement ranges or resolutions correspond to a preset sensing signal resource pattern or parameters associated with different sensing signal resource patterns.

For the manner 2 or the manner 3, a correspondence between the preset first-level resource pattern and indexes of some (or all) of the parameters associated with the second-level resource pattern may be agreed upon in advance by a transceiver device, for example, may be specified in a protocol, or may be notified by the first device to the second device in advance. For example, specific resource pattern associated parameters corresponding to different resource pattern indexes are indicated by using radio resource control (RRC) signaling, and an index value and a parameter related to another sensing signal configuration are indicated by using layer 1 signaling.

### Embodiment 3

In this embodiment, calculation of a sensing measurement result is mainly described.

It should be noted that this embodiment describes calculation of the sensing measurement result. In this embodiment of this application, an algorithm and a processing manner actually used for calculation of the sensing measurement result are not limited, for example, a calculation manner defined in a protocol may be used.

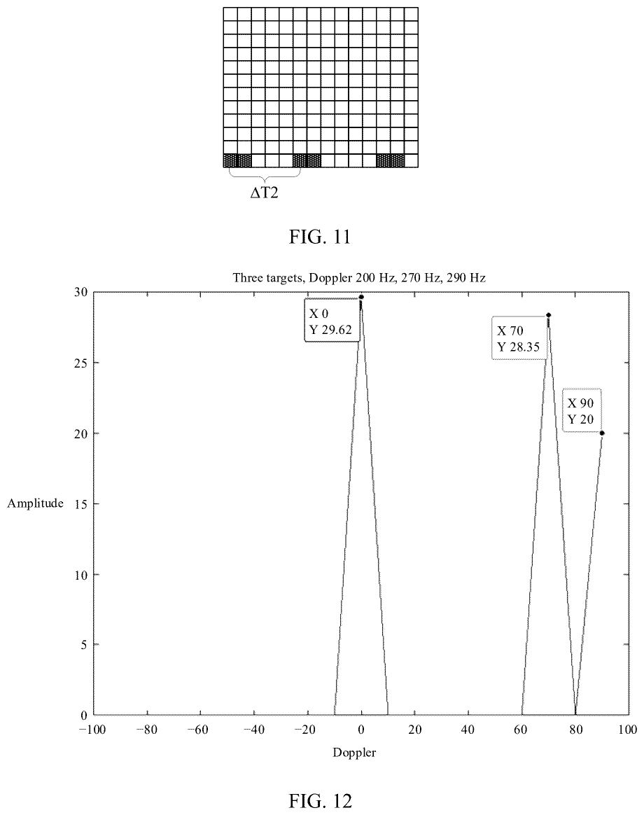

It is assumed that a sensing signal pattern design (that is, a sensing signal pattern design 2 in consecutive mapping in a set in Embodiment 1) in FIG. 11 is used. Each resource set of a sensing signal includes two resource elements consecutive in time domain, a time domain resource element interval in the set is 0.001 s, and a corresponding maximum unambiguous Doppler measurement range is ±500 Hz (a target motion direction is considered). A total time domain resource length of the sensing signal is 0.1 s, that is, 100-time domain resource elements, and a corresponding Doppler resolution is 10 Hz. A time domain interval ΔT2 between resource sets of the sensing signal is 0.005 s, and a corresponding maximum unambiguous Doppler measurement range is ±100 Hz (the target motion direction is considered).

It is assumed that three dynamic targets exist in an environment, and Doppler frequency shift values brought by a target motion are respectively 200 Hz, 270 Hz, and 290 Hz, which exceed the maximum unambiguous Doppler measurement range corresponding to the sensing signal configuration whose time domain interval is 0.005 s.

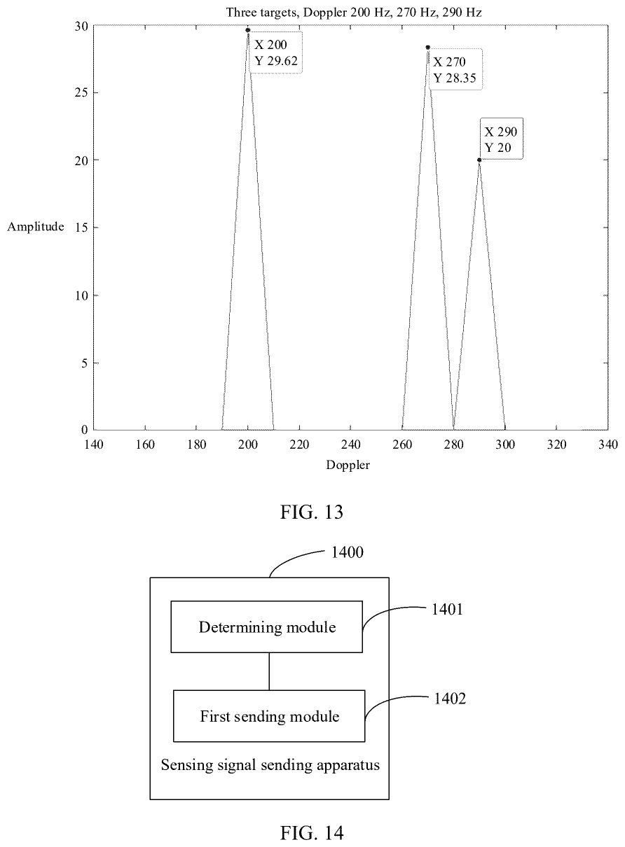

After receiving the sensing signal, a receiving device performs least-square (LS) channel estimation to obtain channel information H corresponding to each time-frequency domain resource element of the sensing signal, so as to obtain phase difference information between the channel information H corresponding to two resource elements in the resource set. To increase a processing gain, average phase difference information of a plurality of resource may be obtained and used as first phase difference information θ. A first Doppler may be obtained based on the phase difference information and a resource value of a resource element in the resource set, that is, f_{d1}≤θ/(2*π*ΔT2)≈240 Hz. A second Doppler value may be obtained by performing an FFT operation based on channel information corresponding to a sensing signal between resource sets (channel information H corresponding to one sensing signal in the set or an average of channel information H corresponding to two sensing signals may be taken), where the second Doppler value is a Doppler value corresponding to three sensing targets in a case that Doppler measurement ambiguity occurs, as shown in FIG. 12. Further, a target Doppler value may be obtained based on the first Doppler value and the second Doppler value, that is, a Doppler value corresponding to the three sensing targets obtained after Doppler measurement ambiguity is removed, as shown in FIG. 13.

In addition, a target radial velocity may be calculated based on the target Doppler value. For the pattern design 1 in Embodiment 1, a method for calculating a delay or a distance is similar to Doppler calculation, and details are not described again.

Further, in addition to a measured delay or distance information, and Doppler or velocity information, the foregoing sensing measurement result may be angle information, or sensing information obtained by further calculation based on the measurement result includes but is not limited to: an orientation, a spatial location, an acceleration, whether a target exists, a track, an action, an expression, a vital sign, a quantity, an imaging result, weather, air quality, a shape, a material, component information, and the like.

In this embodiment of this application, a time-frequency domain pattern of a sensing signal based on a resource set is proposed for function features such as distance measurement and velocity measurement in a sensing service, and a corresponding configuration method and a corresponding measurement and feedback procedure are provided, which have the following advantages:

Maximum unambiguous distance measurement (delay measurement) and velocity measurement (Doppler measurement) requirements are met, thereby ensuring a resolution of distance measurement/velocity measurement, and improving sensing performance.

A flexible resource allocation manner saves overheads while meeting sensing performance.

The sensing signal sending method provided in the embodiments of this application may be performed by a sensing signal sending apparatus. In the embodiments of this application, a sensing signal sending apparatus provided in an embodiment of this application is described by using an example in which the sensing signal sending apparatus performs the sensing signal sending method.

Referring to FIG. 14, FIG. 14 is a structural diagram of a sensing signal sending apparatus according to an embodiment of this application. As shown in FIG. 14, the sensing signal sending apparatus 1400 includes:
a determining module 1401, configured to determine first configuration information, where the first configuration information is used to configure a time-frequency resource pattern of a sensing signal, the time-frequency resource pattern includes at least one resource set used to transmit the sensing signal, and the resource set includes at least two time domain resource elements and at least one frequency domain resource element; and
a first sending module 1402, configured to send the sensing signal based on the time-frequency resource pattern.

Optionally, the sensing signal is used for at least one of the following:
velocity estimation, Doppler estimation, distance estimation, delay estimation, and angle estimation.

Optionally, the resource set meets an unambiguous measurement requirement.

Optionally, a time domain difference between neighboring time domain resource elements in the resource set meets at least one of the following: an unambiguous Doppler measurement requirement and an unambiguous velocity measurement requirement; or
a time domain density in the resource set meets at least one of the following: an unambiguous Doppler measurement requirement and an unambiguous velocity measurement requirement.

Optionally, a frequency domain difference between neighboring frequency domain resource elements in the resource set meets at least one of the following: an unambiguous delay measurement requirement and an unambiguous distance measurement requirement; or
a frequency domain density in the resource set meets at least one of the following: an unambiguous delay measurement requirement and an unambiguous distance measurement requirement.

Optionally, the first configuration information includes at least one of the following:
index information of the resource set; and
parameter information of the resource set.

Optionally, the parameter information of the resource set includes at least one of the following:
a quantity of resource elements in the resource set, the time domain difference between the neighboring time domain resource elements in the resource set, the time domain density in the resource set, the frequency domain difference between the neighboring frequency domain resource elements in the resource set, and the frequency domain density in the resource set.

Optionally, the time-frequency resource pattern meets a resolution requirement.

Optionally, a time domain resource length of the time-frequency resource pattern meets at least one of the following: a Doppler resolution requirement and a velocity resolution requirement.

Optionally, a frequency domain resource length of the time-frequency resource pattern meets at least one of the following: a delay resolution requirement and a distance resolution requirement.

Optionally, the first configuration information includes at least one of the following:
index information of the time-frequency resource pattern; and
parameter information of the time-frequency resource pattern.

Optionally, the parameter information of the time-frequency resource pattern includes at least one of the following:
time domain resource length information, frequency domain resource length information, a start location of the resource set, and a resource difference between neighboring resource sets.

Optionally, the resource difference between the neighboring resource sets includes at least one of the following:
a frequency domain difference between start frequency domain resources of the neighboring resource sets, or a minimum frequency domain difference between the neighboring resource sets; and
a time domain difference between start time domain resources of the neighboring resource sets, or a minimum time domain difference between the neighboring resource sets.

Optionally, the resource difference between the neighboring resource sets is represented in the following manner:
a resource density, a time domain period, a frequency domain period, a time domain index, or a frequency domain index.

Optionally, the first configuration information is further used to indicate at least one of the following:
a signal identifier of the sensing signal, a waveform of the sensing signal, a subcarrier spacing, signal power of the sensing signal, sequence information of the sensing signal, and a signal direction of the sensing signal.

Optionally, the resource set meets at least one of the following:
a resource difference in the resource set is less than a resource difference between neighboring resource sets; and
the resource elements in the resource set are consecutive, or the resource elements in the resource set are inconsecutive.

Optionally, a quantity of frequency domain resource elements in the resource set is 2, a quantity of time domain resource elements in the resource set is 2, the two time domain resource elements are consecutive in time domain, and the two frequency domain resource elements are consecutive in frequency domain; or
a quantity of frequency domain resource elements in the resource set is 1, a quantity of time domain resource elements in the resource set is 2, and the two time domain resource elements are consecutive in time domain.

Optionally, the sensing signal includes:
a signal generated based on at least one of an M sequence, a Gold sequence, a Kasami sequence, a Golay sequence, and a Zadoff-Chu sequence;
communication data;
a radar signal; or
an integrated communication and sensing signal.

Optionally, in a case that the sensing signal is configured for a plurality of ports, resources of the sensing signal are multiplexed on different ports, and the multiplexing includes at least one of time division multiplexing and frequency division multiplexing; or
in a case that the sensing signal is configured for a plurality of ports and resources of the sensing signal on different ports are the same, generation sequences of the sensing signal on different ports are different.

Optionally, the determining module 1401 is configured to:
determine the first configuration information based on sensing requirement information; or
receive the first configuration information sent by a third device.

Optionally, the first sending module 1402 is configured to send the sensing signal to a second device.

Alternatively, the apparatus further includes:
a measurement module, configured to: receive an echo signal of the sensing signal, and perform measurement based on the echo signal.

Optionally, the apparatus further includes at least one of the following:
a second sending module, configured to send at least one of the first configuration information or second configuration information to the second device in a case that the sensing signal is sent to the second device; or
an obtaining module, configured to obtain second configuration information in a case that the first device receives the echo signal of the sensing signal and performs measurement based on the echo signal.

The second configuration information is used to configure at least one of the following:
measurement information and measurement result reporting information.

The measurement information includes a sensing measurement quantity.

The measurement result reporting information includes at least one of the following:
a resource configuration for measurement result reporting;
a time domain measurement result reporting behavior; and
a trigger condition for measurement result reporting.

Optionally, the time domain measurement result reporting behavior includes:
periodic reporting, semi-persistent reporting, or aperiodic reporting.

Optionally, the apparatus further includes at least one of the following:
a receiving module, configured to: in a case that the sensing signal is sent to the second device, receive a measurement result sent by the second device; and
a third sending module, configured to send a measurement result to the third device in a case that the first device receives the echo signal of the sensing signal and performs measurement based on the echo signal.

The measurement result includes at least one of the following:
a first delay calculated based on a sensing signal in the resource set;
a first Doppler calculated based on the sensing signal in the resource set;
first phase difference information calculated based on the sensing signal in the resource set;
a second delay calculated based on a sensing signal between a plurality of resource sets;
a second Doppler calculated based on the sensing signal between the plurality of the resource sets;
a third delay calculated based on the first delay and the second delay;
a distance calculated based on the first delay and the second delay;
a third Doppler calculated based on the first Doppler and the second Doppler;
a velocity calculated based on the first Doppler and the second Doppler; and
a sensing performance indicator.

Optionally, the first device corresponding to the apparatus includes a network side device, the second device includes a terminal, and the third device includes at least one of the following: a core network-sensing network function, a network side device, or a terminal;
the first device includes a network side device, and the third device includes at least one of the following: a core network-sensing network function, a network side device, or a terminal;
the first device includes a network side device, the second device includes a network side device, and the third device includes at least one of the following: a core network-sensing network function, a network side device, or a terminal;
the first device includes a terminal, the second device includes a network side device, and the third device includes at least one of the following: a core network-sensing network function, a network side device, or a terminal;
the first device includes a terminal, the second device includes a terminal, and the third device includes at least one of the following: a core network-sensing network function, a network side device, or a terminal; or
the first device includes a terminal, and the third device includes at least one of the following: a core network-sensing network function, a network side device, or a terminal.

The sensing signal sending apparatus may improve sensing performance.

The sensing signal sending apparatus in this embodiment of this application may be an electronic device, for example, an electronic device with an operating system, or may be a component such as an integrated circuit or a chip in an electronic device. The electronic device may be a terminal, or may be another device different from a terminal. For example, the terminal may include but is not limited to the foregoing listed types of the terminal 11. The another device may be a server, a network attached storage (NAS), or the like. This is not specifically limited in this embodiment of this application.

The sensing signal sending apparatus provided in this embodiment of this application can implement processes implemented in the method embodiment in FIG. 3, and achieve same technical effects. To avoid repetition, details are not described herein again.

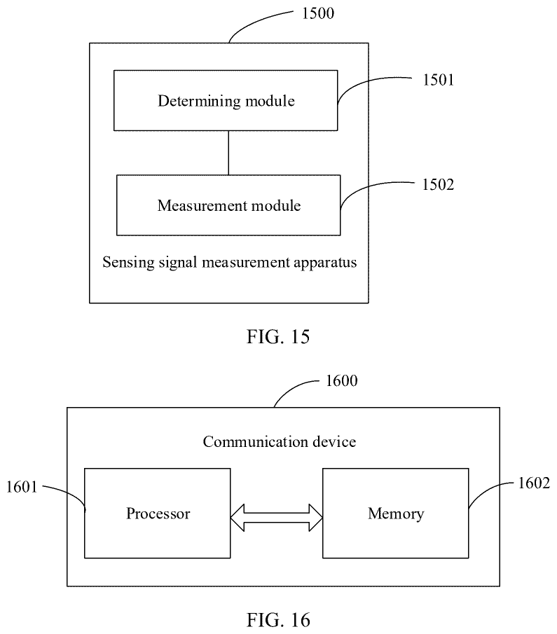

Referring to FIG. 15, FIG. 15 is a structural diagram of a sensing signal measurement apparatus according to an embodiment of this application. As shown in FIG. 15, the sensing signal measurement apparatus 1500 includes:
a determining module 1501, configured to determine first configuration information, where the first configuration information is used to configure a time-frequency resource pattern of a sensing signal, the time-frequency resource pattern includes at least one resource set used to transmit the sensing signal, and the resource set includes at least two time domain resource elements and at least one frequency domain resource element; and
a measurement module 1502, configured to measure the sensing signal based on the first configuration information.

Optionally, the determining module 1501 is configured to:
receive the first configuration information sent by a first device, where the sensing signal is sent by the first device;
receive the first configuration information sent by a third device; or
determine the first configuration information based on sensing requirement information.

Optionally, the sensing signal is used for at least one of the following:
velocity estimation, Doppler estimation, distance estimation, delay estimation, and angle estimation.

Optionally, the resource set meets an unambiguous measurement requirement.

Optionally, a time domain difference between neighboring time domain resource elements in the resource set meets at least one of the following: an unambiguous Doppler measurement requirement and an unambiguous velocity measurement requirement; or
a time domain density in the resource set meets at least one of the following: an unambiguous Doppler measurement requirement and an unambiguous velocity measurement requirement.

Optionally, a frequency domain difference between neighboring frequency domain resource elements in the resource set meets at least one of the following: an unambiguous delay measurement requirement and an unambiguous distance measurement requirement; or
a frequency domain density in the resource set meets at least one of the following: an unambiguous delay measurement requirement and an unambiguous distance measurement requirement.

Optionally, the first configuration information includes at least one of the following:
index information of the resource set; and
parameter information of the resource set.

Optionally, the parameter information of the resource set includes at least one of the following:
a quantity of resource elements in the resource set, the time domain difference between the neighboring time domain resource elements in the resource set, the time domain density in the resource set, the frequency domain difference between the neighboring frequency domain resource elements in the resource set, and the frequency domain density in the resource set.

Optionally, the time-frequency resource pattern meets a resolution requirement.

Optionally, a time domain resource length of the time-frequency resource pattern meets at least one of the following: a Doppler resolution requirement and a velocity resolution requirement.

Optionally, a frequency domain resource length of the time-frequency resource pattern meets at least one of the following: a delay resolution requirement and a distance resolution requirement.

Optionally, the first configuration information includes at least one of the following:
index information of the time-frequency resource pattern; and
parameter information of the time-frequency resource pattern.

The parameter information of the time-frequency resource pattern includes at least one of the following:
time domain resource length information, frequency domain resource length information, a start location of the resource set, and a resource difference between neighboring resource sets.

Optionally, the resource difference between the neighboring resource sets includes at least one of the following:
a frequency domain difference between start frequency domain resources of the neighboring resource sets, or a minimum frequency domain difference between the neighboring resource sets; and
a time domain difference between start time domain resources of the neighboring resource sets, or a minimum time domain difference between the neighboring resource sets.

Optionally, the resource difference between the neighboring resource sets is represented in the following manner:
a resource density, a time domain period, a frequency domain period, a time domain index, or a frequency domain index.

Optionally, the first configuration information is further used to indicate at least one of the following:
a signal identifier of the sensing signal, a waveform of the sensing signal, a subcarrier spacing, signal power of the sensing signal, sequence information of the sensing signal, and a signal direction of the sensing signal.

Optionally, the resource set meets at least one of the following:
a resource difference in the resource set is less than a resource difference between neighboring resource sets; and
the resource elements in the resource set are consecutive, or the resource elements in the resource set are inconsecutive.

Optionally, a quantity of frequency domain resource elements in the resource set is 2, a quantity of time domain resource elements in the resource set is 2, the two time domain resource elements are consecutive in time domain, and the two frequency domain resource elements are consecutive in frequency domain; or
a quantity of frequency domain resource elements in the resource set is 1, a quantity of time domain resource elements in the resource set is 2, and the two time domain resource elements are consecutive in time domain.

Optionally, the sensing signal includes:
a signal generated based on at least one of an M sequence, a Gold sequence, a Kasami sequence, a Golay sequence, and a Zadoff-Chu sequence;
communication data;
a radar signal; or
an integrated communication and sensing signal.

Optionally, in a case that the sensing signal is configured for a plurality of ports, resources of the sensing signal are multiplexed on different ports, and the multiplexing includes at least one of time division multiplexing and frequency division multiplexing; or
in a case that the sensing signal is configured for a plurality of ports and resources of the sensing signal on different ports are the same, generation sequences of the sensing signal on different ports are different.

Optionally, the apparatus further includes:
a receiving module, configured to receive second configuration information sent by the first device.

The second configuration information is used to configure at least one of the following:
measurement information and measurement result reporting information.

The measurement information includes a sensing measurement quantity.

The measurement result reporting information includes at least one of the following:
a resource configuration for measurement result reporting;
a time domain measurement result reporting behavior; and
a trigger condition for measurement result reporting.

Optionally, the time domain measurement result reporting behavior includes:
periodic reporting, semi-persistent reporting, or aperiodic reporting.

Optionally, the apparatus further includes at least one of the following:
a sending module, configured to send a measurement result to the first device.

The measurement result includes at least one of the following:
a first delay calculated based on a sensing signal in the resource set;
a first Doppler calculated based on the sensing signal in the resource set;
first phase difference information calculated based on the sensing signal in the resource set;
a second delay calculated based on a sensing signal between a plurality of resource sets;
a second Doppler calculated based on the sensing signal between the plurality of the resource sets;
a third delay calculated based on the first delay and the second delay;
a distance calculated based on the first delay and the second delay;
a third Doppler calculated based on the first Doppler and the second Doppler;
a velocity calculated based on the first Doppler and the second Doppler; and
a sensing performance indicator.

Optionally, the first device includes a network side device, a second device corresponding to the apparatus includes a terminal, and the third device includes at least one of the following: a core network-sensing network function, a network side device, or a terminal;
the first device includes a network side device, and the third device includes at least one of the following: a core network-sensing network function, a network side device, or a terminal;
the first device includes a network side device, the second device includes a network side device, and the third device includes at least one of the following: a core network-sensing network function, a network side device, or a terminal;
the first device includes a terminal, the second device includes a network side device, and the third device includes at least one of the following: a core network-sensing network function, a network side device, or a terminal;
the first device includes a terminal, the second device includes a terminal, and the third device includes at least one of the following: a core network-sensing network function, a network side device, or a terminal; or
the first device includes a terminal, and the third device includes at least one of the following: a core network-sensing network function, a network side device, or a terminal.

The sensing signal measurement apparatus may improve sensing performance.

The sensing signal measurement apparatus in this embodiment of this application may be an electronic device, for example, an electronic device with an operating system, or may be a component such as an integrated circuit or a chip in an electronic device. The electronic device may be a terminal or a network side device.

The sensing signal measurement apparatus provided in this embodiment of this application can implement processes implemented in the method embodiment in FIG. 10, and achieve same technical effects. To avoid repetition, details are not described herein again.

As shown in FIG. 16, an embodiment of this application further provides a communication device 1600, including a processor 1601 and a memory 1602. The memory 1602 stores a program or instructions capable of running on the processor 1601. For example, when the communication device 1600 is a terminal, the program or the instructions are executed by the processor 1601 to implement the steps of the embodiment of the sensing signal sending method or the sensing signal measurement method, and same technical effects can be achieved. When the communication device 1600 is a network side device, the program or the instructions are executed by the processor 1601 to implement the steps in the embodiment of the sensing signal sending method or the sensing signal measurement method, and same technical effects can be achieved. To avoid repetition, details are not described herein again.

An embodiment of this application further provides a communication device, including a processor and a communication interface. The communication interface is coupled to the processor. The processor is configured to run a program or an instruction to implement the steps in the method embodiment shown in FIG. 3 or FIG. 10. The embodiment corresponds to the foregoing method embodiment. Each implementation process and implementation of the foregoing method embodiment may be applied to the terminal embodiment, and same technical effects can be achieved.

An embodiment of this application further provides a communication device, including a processor and a communication interface. The processor or the communication interface is configured to determine first configuration information, where the first configuration information is used to configure a time-frequency resource pattern of a sensing signal, the time-frequency resource pattern includes at least one resource set used to transmit the sensing signal, and the resource set includes at least two time domain resource elements and at least one frequency domain resource element. The communication interface is configured to send the sensing signal based on the time-frequency resource pattern. The embodiment corresponds to the foregoing method embodiment. Each implementation process and implementation of the foregoing method embodiment may be applied to the communication device embodiment, and same technical effects can be achieved.

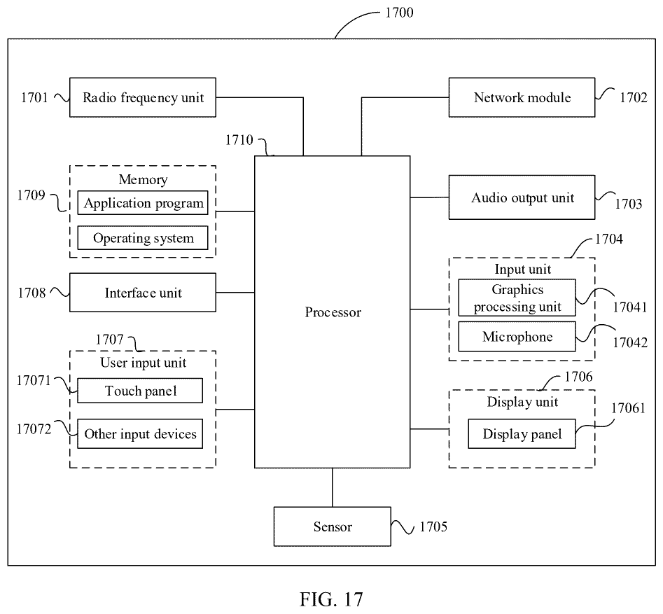

Specifically, FIG. 17 is a schematic diagram of a hardware structure of a communication device for implementing an embodiment of this application.

The communication device 1700 includes but is not limited to at least a part of components in a radio frequency unit 1701, a network module 1702, an audio output unit 1703, an input unit 1704, a sensor 1705, a display unit 1706, a user input unit 1707, an interface unit 1708, a memory 1709, a processor 1710, and the like.

A person skilled in the art may understand that the communication device 1700 may further include a power supply (for example, a battery) that supplies power to each component, and the power supply may be logically connected to the processor 1710 by using a power management system, to implement functions such as charging management, discharging management, and power consumption management by using the power management system. The structure of the communication device shown in FIG. 17 does not constitute a limitation on the communication device. The communication device may include more or fewer components than those shown in the figure, or combine some components, or have different component arrangements. Details are not described herein again.

It should be understood that in this embodiment of this application, the input unit 1704 may include a graphics processing unit (GPU) 17041 and a microphone 17042, and the graphics processing unit 17041 processes image data of a still picture or a video obtained by an image capture apparatus (for example, a camera) in a video capture mode or an image capture mode. The display unit 1706 may include a display panel 17061, and the display panel 17061 may be configured in a form of a liquid crystal display, an organic light-emitting diode, or the like. The user input unit 1707 includes at least one of a touch panel 17071 and other input devices 17072. The touch panel 17071 is also referred to as a touchscreen. The touch panel 17071 may include two parts: a touch detection apparatus and a touch controller. The other input devices 17072 may include but are not limited to a physical keyboard, a function key (such as a volume control key or an on/off key), a trackball, a mouse, and a joystick. Details are not described herein again.

In this embodiment of this application, after receiving downlink data from a network side device, the radio frequency unit 1701 may transmit the downlink data to the processor 1710 for processing. In addition, the radio frequency unit 1701 may send uplink data to a network side device. Generally, the radio frequency unit 1701 includes but is not limited to an antenna, an amplifier, a transceiver, a coupler, a low-noise amplifier, a duplexer, and the like.

The memory 1709 may be configured to store a software program or instructions and various types of data. The memory 1709 may mainly include a first storage region for storing a program or instructions and a second storage region for storing data. The first storage region may store an operating system, an application program or instructions required by at least one function (for example, a sound play function or an image play function), and the like. In addition, the memory 1709 may include a volatile memory or a nonvolatile memory. The nonvolatile memory may be a read-only memory (ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (RAM), a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDRSDRAM), an enhanced synchronous dynamic random access memory (Enhanced SDRAM, ESDRAM), a synch link dynamic random access memory (Synch link DRAM, SLDRAM), and a direct rambus random access memory (Direct Rambus RAM, DRRAM). The memory 1709 in this embodiment of this application includes but is not limited to these memories and any other suitable type of memory.

The processor 1710 may include one or more processing units. Optionally, the processor 1710 integrates an application processor and a modem processor. The application processor mainly processes operations related to an operating system, a user interface, an application program, and the like. The modem processor, for example, a baseband processor, mainly processes a wireless communication signal. It may be understood that, the foregoing modem processor may not be integrated into the processor 1710.

In this embodiment, an example in which the foregoing device is a first device is used for description.

The processor 1710 or the radio frequency unit 1701 is configured to determine first configuration information, where the first configuration information is used to configure a time-frequency resource pattern of a sensing signal, the time-frequency resource pattern includes at least one resource set used to transmit the sensing signal, and the resource set includes at least two time domain resource elements and at least one frequency domain resource element.

The radio frequency unit 1701 sends the sensing signal based on the time-frequency resource pattern.

Optionally, the sensing signal is used for at least one of the following:
velocity estimation, Doppler estimation, distance estimation, delay estimation, and angle estimation.

Optionally, the resource set meets an unambiguous measurement requirement.

Optionally, a time domain difference between neighboring time domain resource elements in the resource set meets at least one of the following: an unambiguous Doppler measurement requirement and an unambiguous velocity measurement requirement; or
a time domain density in the resource set meets at least one of the following: an unambiguous Doppler measurement requirement and an unambiguous velocity measurement requirement.

Optionally, a frequency domain difference between neighboring frequency domain resource elements in the resource set meets at least one of the following: an unambiguous delay measurement requirement and an unambiguous distance measurement requirement; or
a frequency domain density in the resource set meets at least one of the following: an unambiguous delay measurement requirement and an unambiguous distance measurement requirement.

Optionally, the first configuration information includes at least one of the following:
index information of the resource set; and
parameter information of the resource set.

Optionally, the parameter information of the resource set includes at least one of the following:
a quantity of resource elements in the resource set, the time domain difference between the neighboring time domain resource elements in the resource set, the time domain density in the resource set, the frequency domain difference between the neighboring frequency domain resource elements in the resource set, and the frequency domain density in the resource set.

Optionally, the time-frequency resource pattern meets a resolution requirement.

Optionally, a time domain resource length of the time-frequency resource pattern meets at least one of the following: a Doppler resolution requirement and a velocity resolution requirement.

Optionally, a frequency domain resource length of the time-frequency resource pattern meets at least one of the following: a delay resolution requirement and a distance resolution requirement.

Optionally, the first configuration information includes at least one of the following:
index information of the time-frequency resource pattern; and
parameter information of the time-frequency resource pattern.

Optionally, the parameter information of the time-frequency resource pattern includes at least one of the following:
time domain resource length information, frequency domain resource length information, a start location of the resource set, and a resource difference between neighboring resource sets.

Optionally, the resource difference between the neighboring resource sets includes at least one of the following:
a frequency domain difference between start frequency domain resources of the neighboring resource sets, or a minimum frequency domain difference between the neighboring resource sets; and
a time domain difference between start time domain resources of the neighboring resource sets, or a minimum time domain difference between the neighboring resource sets.

Optionally, the resource difference between the neighboring resource sets is represented in the following manner:
a resource density, a time domain period, a frequency domain period, a time domain index, or a frequency domain index.

Optionally, the first configuration information is further used to indicate at least one of the following:
a signal identifier of the sensing signal, a waveform of the sensing signal, a subcarrier spacing, signal power of the sensing signal, sequence information of the sensing signal, and a signal direction of the sensing signal.

Optionally, the resource set meets at least one of the following:
a resource difference in the resource set is less than a resource difference between neighboring resource sets; and
the resource elements in the resource set are consecutive, or the resource elements in the resource set are inconsecutive.

Optionally, a quantity of frequency domain resource elements in the resource set is 2, a quantity of time domain resource elements in the resource set is 2, the two time domain resource elements are consecutive in time domain, and the two frequency domain resource elements are consecutive in frequency domain; or
a quantity of frequency domain resource elements in the resource set is 1, a quantity of time domain resource elements in the resource set is 2, and the two time domain resource elements are consecutive in time domain.

Optionally, the sensing signal includes:
a signal generated based on at least one of an M sequence, a Gold sequence, a Kasami sequence, a Golay sequence, and a Zadoff-Chu sequence;
communication data;
a radar signal; or
an integrated communication and sensing signal.

Optionally, in a case that the sensing signal is configured for a plurality of ports, resources of the sensing signal are multiplexed on different ports, and the multiplexing includes at least one of time division multiplexing and frequency division multiplexing; or
in a case that the sensing signal is configured for a plurality of ports and resources of the sensing signal on different ports are the same, generation sequences of the sensing signal on different ports are different.

Optionally, the determining first configuration information includes:
determine the first configuration information based on sensing requirement information; or
receive the first configuration information sent by a third device.

Optionally, the sending the sensing signal includes: sending the sensing signal to a second device.

Alternatively, the radio frequency unit 1701 is further configured to:
receive an echo signal of the sensing signal, and perform measurement based on the echo signal.

Optionally, the radio frequency unit 1701 is further configured to perform at least one of the following:
sending at least one of the first configuration information or second configuration information to the second device in a case that the sensing signal is sent to the second device; or
obtaining second configuration information in a case that the first device receives the echo signal of the sensing signal and performs measurement based on the echo signal.

The second configuration information is used to configure at least one of the following:
measurement information and measurement result reporting information.

The measurement information includes a sensing measurement quantity.

The measurement result reporting information includes at least one of the following:
a resource configuration for measurement result reporting;
a time domain measurement result reporting behavior; and
a trigger condition for measurement result reporting.

Optionally, the time domain measurement result reporting behavior includes:
periodic reporting, semi-persistent reporting, or aperiodic reporting.

Optionally, the radio frequency unit 1701 is further configured to perform at least one of the following:
in a case that the sensing signal is sent to the second device, receiving a measurement result sent by the second device; and
sending a measurement result to the third device in a case that the first device receives the echo signal of the sensing signal and performs measurement based on the echo signal.

The measurement result includes at least one of the following:
a first delay calculated based on a sensing signal in the resource set;
a first Doppler calculated based on the sensing signal in the resource set;
first phase difference information calculated based on the sensing signal in the resource set;
a second delay calculated based on a sensing signal between a plurality of resource sets;
a second Doppler calculated based on the sensing signal between the plurality of the resource sets;
a third delay calculated based on the first delay and the second delay;
a distance calculated based on the first delay and the second delay;
a third Doppler calculated based on the first Doppler and the second Doppler;
a velocity calculated based on the first Doppler and the second Doppler; and
a sensing performance indicator.

Optionally, the communication device is the first device, the first device includes a network side device, the second device includes a terminal, and the third device includes at least one of the following: a core network-sensing network function, a network side device, or a terminal;
the first device includes a network side device, and the third device includes at least one of the following: a core network-sensing network function, a network side device, or a terminal;
the first device includes a network side device, the second device includes a network side device, and the third device includes at least one of the following: a core network-sensing network function, a network side device, or a terminal;
the first device includes a terminal, the second device includes a network side device, and the third device includes at least one of the following: a core network-sensing network function, a network side device, or a terminal;
the first device includes a terminal, the second device includes a terminal, and the third device includes at least one of the following: a core network-sensing network function, a network side device, or a terminal; or
the first device includes a terminal, and the third device includes at least one of the following: a core network-sensing network function, a network side device, or a terminal.

It should be noted that in this embodiment, an example in which the communication device is a terminal is used for description.

The communication device may improve sensing performance.

It may be understood that, for implementation processes of the implementations mentioned in this embodiment, refer to related descriptions in the embodiment of the sensing signal sending method, and same or corresponding technical effects are achieved. To avoid repetition, details are not described herein again.

An embodiment of this application further provides a communication device, including a processor and a communication interface. The communication interface is coupled to the processor. The processor is configured to run a program or instructions to implement the steps in the method embodiment shown in FIG. 10. The communication device embodiment corresponds to the embodiment of the sensing signal measurement method, and each implementation process and implementation of the method embodiment may be applied to this communication device embodiment, and same technical effects can be achieved.

An embodiment of this application further provides a communication device, including a processor and a communication interface. The processor or the communication interface is configured to determine first configuration information, where the first configuration information is used to configure a time-frequency resource pattern of a sensing signal, the time-frequency resource pattern includes at least one resource set used to transmit the sensing signal, and the resource set includes at least two time domain resource elements and at least one frequency domain resource element. The communication interface is configured to measure the sensing signal based on the first configuration information. The embodiment corresponds to the foregoing method embodiment. Each implementation process and implementation of the foregoing method embodiment may be applied to the terminal embodiment, and same technical effects can be achieved.

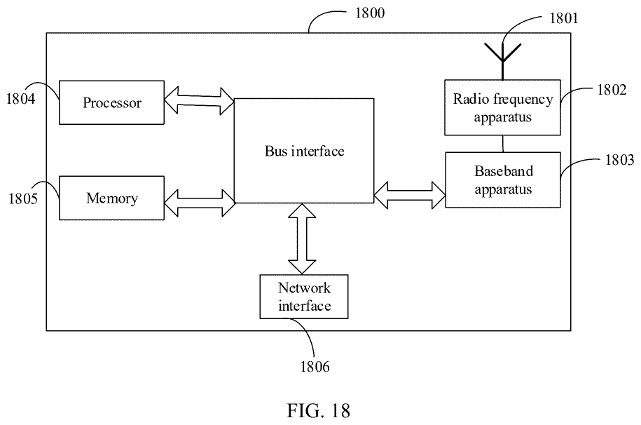

Specifically, an embodiment of this application further provides a communication device. As shown in FIG. 18, the communication device 1800 includes an antenna 1801, a radio frequency apparatus 1802, a baseband apparatus 1803, a processor 1804, and a memory 1805. The antenna 1801 is connected to the radio frequency apparatus 1802. In an uplink direction, the radio frequency apparatus 1802 receives information through the antenna 1801, and sends the received information to the baseband apparatus 1803 for processing. In a downlink direction, the baseband apparatus 1803 processes to-be-sent information, and sends processed information to the radio frequency apparatus 1802. After processing the received information, the radio frequency apparatus 1802 sends processed information through the antenna 1801.

The method performed by the communication device in the foregoing embodiment may be implemented in the baseband apparatus 1803, and the baseband apparatus 1803 includes a baseband processor.

For example, the baseband apparatus 1803 may include at least one baseband board. A plurality of chips are disposed on the baseband board. As shown in FIG. 18, one of the chips is, for example, the baseband processor, and is connected to the memory 1805 by using a bus interface, to invoke a program in the memory 1805 to perform an operation of a network device shown in the foregoing method embodiment.

The communication device may further include a network interface 1806, and the interface is, for example, a common public radio interface (CPRI).

Specifically, the communication device 1800 in this embodiment of this application further includes instructions or a program stored in the memory 1805 and capable of running on the processor 1804. The processor 1804 invokes the instructions or the program in the memory 1805 to perform the method performed by the modules shown in FIG. 14 or FIG. 15, and same technical effects are achieved. To avoid repetition, details are not described herein again.

In this embodiment, an example in which the foregoing device is a second device is used for description.

The radio frequency apparatus 1802 or the processor 1804 is configured to determine first configuration information, where the first configuration information is used to configure a time-frequency resource pattern of a sensing signal, the time-frequency resource pattern includes at least one resource set used to transmit the sensing signal, and the resource set includes at least two time domain resource elements and at least one frequency domain resource element.

The radio frequency apparatus 1802 is configured to measure the sensing signal based on the first configuration information.

Optionally, the determining first configuration information includes:
receiving the first configuration information sent by a first device, where the sensing signal is sent by the first device;
receiving the first configuration information sent by a third device; or
determining the first configuration information based on sensing requirement information.

Optionally, the sensing signal is used for at least one of the following:
velocity estimation, Doppler estimation, distance estimation, delay estimation, and angle estimation.

Optionally, the resource set meets an unambiguous measurement requirement.

Optionally, a time domain difference between neighboring time domain resource elements in the resource set meets at least one of the following: an unambiguous Doppler measurement requirement and an unambiguous velocity measurement requirement; or
a time domain density in the resource set meets at least one of the following: an unambiguous Doppler measurement requirement and an unambiguous velocity measurement requirement.

Optionally, a frequency domain difference between neighboring frequency domain resource elements in the resource set meets at least one of the following: an unambiguous delay measurement requirement and an unambiguous distance measurement requirement; or
a frequency domain density in the resource set meets at least one of the following: an unambiguous delay measurement requirement and an unambiguous distance measurement requirement.

Optionally, the first configuration information includes at least one of the following:
index information of the resource set; and
parameter information of the resource set.

Optionally, the parameter information of the resource set includes at least one of the following:
a quantity of resource elements in the resource set, the time domain difference between the neighboring time domain resource elements in the resource set, the time domain density in the resource set, the frequency domain difference between the neighboring frequency domain resource elements in the resource set, and the frequency domain density in the resource set.

Optionally, the time-frequency resource pattern meets a resolution requirement.

Optionally, a time domain resource length of the time-frequency resource pattern meets at least one of the following: a Doppler resolution requirement and a velocity resolution requirement.

Optionally, a frequency domain resource length of the time-frequency resource pattern meets at least one of the following: a delay resolution requirement and a distance resolution requirement.

Optionally, the first configuration information includes at least one of the following:
index information of the time-frequency resource pattern; and
parameter information of the time-frequency resource pattern.

The parameter information of the time-frequency resource pattern includes at least one of the following:
time domain resource length information, frequency domain resource length information, a start location of the resource set, and a resource difference between neighboring resource sets.

Optionally, the resource difference between the neighboring resource sets includes at least one of the following:
a frequency domain difference between start frequency domain resources of the neighboring resource sets, or a minimum frequency domain difference between the neighboring resource sets; and
a time domain difference between start time domain resources of the neighboring resource sets, or a minimum time domain difference between the neighboring resource sets.

Optionally, the resource difference between the neighboring resource sets is represented in the following manner:
a resource density, a time domain period, a frequency domain period, a time domain index, or a frequency domain index.

Optionally, the first configuration information is further used to indicate at least one of the following:
a signal identifier of the sensing signal, a waveform of the sensing signal, a subcarrier spacing, signal power of the sensing signal, sequence information of the sensing signal, and a signal direction of the sensing signal.

Optionally, the resource set meets at least one of the following:
a resource difference in the resource set is less than a resource difference between neighboring resource sets; and
the resource elements in the resource set are consecutive, or the resource elements in the resource set are inconsecutive.

Optionally, a quantity of frequency domain resource elements in the resource set is 2, a quantity of time domain resource elements in the resource set is 2, the two time domain resource elements are consecutive in time domain, and the two frequency domain resource elements are consecutive in frequency domain; or
a quantity of frequency domain resource elements in the resource set is 1, a quantity of time domain resource elements in the resource set is 2, and the two time domain resource elements are consecutive in time domain.

Optionally, the sensing signal includes:
a signal generated based on at least one of an M sequence, a Gold sequence, a Kasami sequence, a Golay sequence, and a Zadoff-Chu sequence;
communication data;
a radar signal; or
an integrated communication and sensing signal.

Optionally, in a case that the sensing signal is configured for a plurality of ports, resources of the sensing signal are multiplexed on different ports, and the multiplexing includes at least one of time division multiplexing and frequency division multiplexing; or
in a case that the sensing signal is configured for a plurality of ports and resources of the sensing signal on different ports are the same, generation sequences of the sensing signal on different ports are different.

Optionally, the radio frequency apparatus 1802 is further configured to:
receive second configuration information sent by the first device.

The second configuration information is used to configure at least one of the following:
measurement information and measurement result reporting information.

The measurement information includes a sensing measurement quantity.

The measurement result reporting information includes at least one of the following:
a resource configuration for measurement result reporting;
a time domain measurement result reporting behavior; and
a trigger condition for measurement result reporting.

Optionally, the time domain measurement result reporting behavior includes:
periodic reporting, semi-persistent reporting, or aperiodic reporting.

Optionally, the method further includes at least one of the following:
sending, by the second device, a measurement result to the first device.

The measurement result includes at least one of the following:
a first delay calculated based on a sensing signal in the resource set;
a first Doppler calculated based on the sensing signal in the resource set;
first phase difference information calculated based on the sensing signal in the resource set;
a second delay calculated based on a sensing signal between a plurality of resource sets;
a second Doppler calculated based on the sensing signal between the plurality of the resource sets;
a third delay calculated based on the first delay and the second delay;
a distance calculated based on the first delay and the second delay;
a third Doppler calculated based on the first Doppler and the second Doppler;
a velocity calculated based on the first Doppler and the second Doppler; and
a sensing performance indicator.

Optionally, the first device includes a network side device, the communication device includes a terminal, and the third device includes at least one of the following: a core network-sensing network function, a network side device, or a terminal;
the first device includes a network side device, and the third device includes at least one of the following: a core network-sensing network function, a network side device, or a terminal;
the first device includes a network side device, the communication device includes a network side device, and the third device includes at least one of the following: a core network-sensing network function, a network side device, or a terminal;
the first device includes a terminal, the communication device includes a network side device, and the third device includes at least one of the following: a core network-sensing network function, a network side device, or a terminal;
the first device includes a terminal, the communication device includes a terminal, and the third device includes at least one of the following: a core network-sensing network function, a network side device, or a terminal; or
the first device includes a terminal, and the third device includes at least one of the following: a core network-sensing network function, a network side device, or a terminal.

It should be noted that in this embodiment, an example in which the communication device is a network side device is used for description.

The communication device may improve sensing performance.

An embodiment of this application further provides a readable storage medium. The readable storage medium stores a program or instructions. The program or the instructions are executed by a processor to implement the processes in the foregoing embodiment of the sensing signal sending method or the sensing signal measurement method, and same technical effects can be achieved. To avoid repetition, details are not described herein again.

The processor is a processor in the terminal in the foregoing embodiment. The readable storage medium includes a computer-readable storage medium, such as a computer read-only memory ROM, a random access memory RAM, a magnetic disk, or an optical disc. In some examples, the readable storage medium may be a non-transient readable storage medium.

An embodiment of this application further provides a chip. The chip includes a processor and a communication interface. The communication interface is coupled to the processor. The processor is configured to run a program or instructions to implement the processes in the foregoing embodiment of the sensing signal sending method or the sensing signal measurement method, and same technical effects can be achieved. To avoid repetition, details are not described herein again.

It should be understood that, the chip mentioned in this embodiment of this application may also be referred to as a system-level chip, a system chip, a chip system, a system on chip, or the like.

An embodiment of this application further provides a computer program/program product. The computer program/program product is stored in a storage medium. The computer program/program product is executed by at least one processor to implement the foregoing method of the sensing signal sending method or the sensing signal measurement method, and same technical effects can be achieved. To avoid repetition, details are not described herein again.

An embodiment of this application further provides a sensing measurement system, including a first device and a second device. The first device may be configured to perform the steps of the sensing signal sending method provided in the embodiments of this application, and the second device may be configured to perform the steps of the sensing signal measurement method provided in the embodiments of this application.

It should be noted that in this specification, the term “comprise”, “include”, or any of their variants are intended to cover a non-exclusive inclusion, so that a process, a method, an article, or an apparatus that includes a list of elements not only includes those elements but also includes other elements that are not expressly listed, or further includes elements inherent to such process, method, article, or apparatus. Without more constraints, an element preceded by “includes a . . . ” does not preclude the existence of additional identical elements in the process, method, article, or apparatus that includes the element. In addition, it should be noted that the scope of the method and apparatus in the implementations of this application is not limited to performing functions in a sequence shown or discussed, and may further include performing functions in a basically simultaneous manner or in a reverse sequence based on the functions involved. For example, the described method may be performed in an order different from the described order, and various steps may be added, omitted, or combined. In addition, features described with reference to some examples may be combined in other examples.

According to the foregoing descriptions of the implementations, a person skilled in the art may clearly understand that the method in the foregoing embodiments may be implemented by a computer software product and a necessary general-purpose hardware platform, or certainly may be implemented by hardware. The computer software product is stored in a storage medium (such as a ROM, a RAM, a magnetic disk, or an optical disc) and includes several instructions for instructing a terminal or a network side device to perform the methods described in the embodiments of this application.

The foregoing describes the embodiments of this application with reference to the accompanying drawings. However, this application is not limited to the foregoing specific implementations. The foregoing specific implementations are merely illustrative rather than restrictive. Inspired by this application, a person of ordinary skill in the art may develop many forms of implementations without departing from principles of this application and the protection scope of the claims, and all such implementations fall within the protection scope of this application.

1. A sensing signal sending method, comprising:
determining, by a first device, first configuration information, wherein the first configuration information is used to configure a time-frequency resource pattern of a sensing signal, the time-frequency resource pattern comprises at least one resource set used to transmit the sensing signal, and the resource set comprises at least two time domain resource elements and at least one frequency domain resource element; and
sending, by the first device, the sensing signal based on the time-frequency resource pattern.

2. The method according to claim 1, wherein the sensing signal is used for at least one of the following:
velocity estimation, Doppler estimation, distance estimation, delay estimation, and angle estimation.

3. The method according to claim 1, wherein the resource set meets an unambiguous measurement requirement,
wherein a time domain difference between neighboring time domain resource elements in the resource set meets at least one of the following: an unambiguous Doppler measurement requirement and an unambiguous velocity measurement requirement; or
a time domain density in the resource set meets at least one of the following: an unambiguous Doppler measurement requirement and an unambiguous velocity measurement requirement; or
a frequency domain difference between neighboring frequency domain resource elements in the resource set meets at least one of the following: an unambiguous delay measurement requirement and an unambiguous distance measurement requirement; or
a frequency domain density in the resource set meets at least one of the following: an unambiguous delay measurement requirement and an unambiguous distance measurement requirement.

4. The method according to claim 1, wherein the first configuration information comprises at least one of the following:
index information of the resource set; and
parameter information of the resource set,
wherein the parameter information of the resource set comprises at least one of the following:
a quantity of resource elements in the resource set, the time domain difference between the neighboring time domain resource elements in the resource set, the time domain density in the resource set, the frequency domain difference between the neighboring frequency domain resource elements in the resource set, and the frequency domain density in the resource set.

5. The method according to claim 1, wherein the time-frequency resource pattern meets a resolution requirement,
wherein a time domain resource length of the time-frequency resource pattern meets at least one of the following: a Doppler resolution requirement and a velocity resolution requirement, or
wherein a frequency domain resource length of the time-frequency resource pattern meets at least one of the following: a delay resolution requirement and a distance resolution requirement.

6. The method according to claim 1, wherein the first configuration information comprises at least one of the following:
index information of the time-frequency resource pattern; and
parameter information of the time-frequency resource pattern,
the parameter information of the time-frequency resource pattern comprises at least one of the following:
time domain resource length information, frequency domain resource length information, a start location of the resource set, and a resource difference between neighboring resource sets, and
wherein the resource difference between the neighboring resource sets comprises at least one of the following:
a frequency domain difference between start frequency domain resources of the neighboring resource sets, or a minimum frequency domain difference between the neighboring resource sets; and
a time domain difference between start time domain resources of the neighboring resource sets, or a minimum time domain difference between the neighboring resource sets, or
wherein the resource difference between the neighboring resource sets is represented in the following manner:
a resource density, a time domain period, a frequency domain period, a time domain index, or a frequency domain index.

7. The method according to claim 1, wherein the first configuration information is further used to indicate at least one of the following:
a signal identifier of the sensing signal, a waveform of the sensing signal, a subcarrier spacing, signal power of the sensing signal, sequence information of the sensing signal, and a signal direction of the sensing signal.

8. The method according to claim 1, wherein the resource set meets at least one of the following:
a resource difference in the resource set is less than a resource difference between neighboring resource sets; and
the resource elements in the resource set are consecutive, or the resource elements in the resource set are inconsecutive.

9. The method according to claim 1, wherein a quantity of frequency domain resource elements in the resource set is 2, a quantity of time domain resource elements in the resource set is 2, the two time domain resource elements are consecutive in time domain, and the two frequency domain resource elements are consecutive in frequency domain; or
a quantity of frequency domain resource elements in the resource set is 1, a quantity of time domain resource elements in the resource set is 2, and the two time domain resource elements are consecutive in time domain.

10. The method according to claim 1, wherein the sensing signal comprises:
a signal generated based on at least one of an M sequence, a Gold sequence, a Kasami sequence, a Golay sequence, and a Zadoff-Chu sequence;
communication data;
a radar signal; or
an integrated communication and sensing signal.

11. The method according to claim 1, wherein in a case that the sensing signal is configured for a plurality of ports, resources of the sensing signal are multiplexed on different ports, and the multiplexing comprises at least one of time division multiplexing and frequency division multiplexing; or
in a case that the sensing signal is configured for a plurality of ports and resources of the sensing signal on different ports are the same, generation sequences of the sensing signal on different ports are different.

12. The method according to claim 1, wherein the determining, by a first device, first configuration information comprises:
determining, by the first device, the first configuration information based on sensing requirement information; or
receiving, by the first device, the first configuration information sent by a third device.

13. The method according to claim 1, wherein the sending the sensing signal comprises: sending the sensing signal to a second device; or
the method further comprises:
receiving, by the first device, an echo signal of the sensing signal, and performing measurement based on the echo signal,
wherein the method further comprises at least one of the following:
sending, by the first device, at least one of the first configuration information or second configuration information to the second device in a case that the sensing signal is sent to the second device; or
obtaining, by the first device, second configuration information in a case that the first device receives the echo signal of the sensing signal and performs measurement based on the echo signal, wherein
the second configuration information is used to configure at least one of the following:
measurement information and measurement result reporting information;
the measurement information comprises a sensing measurement quantity; and
the measurement result reporting information comprises at least one of the following:
a resource configuration for measurement result reporting;
a time domain measurement result reporting behavior; and
a trigger condition for measurement result reporting, and
wherein the time domain measurement result reporting behavior comprises:
periodic reporting, semi-persistent reporting, or aperiodic reporting.

14. The method according to claim 13, wherein the method further comprises at least one of the following:
in a case that the sensing signal is sent to the second device, receiving, by the first device, a measurement result sent by the second device; and
sending, by the first device, a measurement result to the third device in a case that the first device receives the echo signal of the sensing signal and performs measurement based on the echo signal, wherein
the measurement result comprises at least one of the following:
a first delay calculated based on a sensing signal in the resource set;
a first Doppler calculated based on the sensing signal in the resource set;
first phase difference information calculated based on the sensing signal in the resource set;
a second delay calculated based on a sensing signal between a plurality of resource sets;
a second Doppler calculated based on the sensing signal between the plurality of the resource sets;
a third delay calculated based on the first delay and the second delay;
a distance calculated based on the first delay and the second delay;
a third Doppler calculated based on the first Doppler and the second Doppler;
a velocity calculated based on the first Doppler and the second Doppler; and
a sensing performance indicator, and
wherein the first device comprises a network side device, the second device comprises a terminal, and the third device comprises at least one of the following: a core network-sensing network function, a network side device, or a terminal;
the first device comprises a network side device, and the third device comprises at least one of the following: a core network-sensing network function, a network side device, or a terminal;
the first device comprises a network side device, the second device comprises a network side device, and the third device comprises at least one of the following: a core network-sensing network function, a network side device, or a terminal;
the first device comprises a terminal, the second device comprises a network side device, and the third device comprises at least one of the following: a core network-sensing network function, a network side device, or a terminal;
the first device comprises a terminal, the second device comprises a terminal, and the third device comprises at least one of the following: a core network-sensing network function, a network side device, or a terminal; or
the first device comprises a terminal, and the third device comprises at least one of the following: a core network-sensing network function, a network side device, or a terminal.

15. A sensing signal measurement method, comprising:
determining, by a second device, first configuration information, wherein the first configuration information is used to configure a time-frequency resource pattern of a sensing signal, the time-frequency resource pattern comprises at least one resource set used to transmit the sensing signal, and the resource set comprises at least two time domain resource elements and at least one frequency domain resource element; and
measuring, by the second device, the sensing signal based on the first configuration information.

16. The method according to claim 15, wherein the determining, by a second device, first configuration information comprises:
receiving, by the second device, the first configuration information sent by a first device, wherein the sensing signal is sent by the first device;
receiving, by the second device, the first configuration information sent by a third device; or
determining, by the second device, the first configuration information based on sensing requirement information.

17. The method according to claim 15, wherein the sensing signal is used for at least one of the following:
velocity estimation, Doppler estimation, distance estimation, delay estimation, and angle estimation.

18. The method according to claim 15, wherein the resource set meets an unambiguous measurement requirement.

19. A communication device, comprising at least one hardware processor and a memory, wherein the memory stores a program or instructions executable by the at least one hardware processor, and the program or the instructions are executed by the at least one hardware processor to implement the sensing signal sending method according to claim 1.

20. A communication device, comprising at least one hardware processor and a memory, wherein the memory stores a program or instructions executable by the at least one hardware processor, and the program or the instructions are executed by the at least one hardware processor to implement the the sensing signal sending method according to claim 15.
